(19) United States
(12) Patent Application Publication
(10) Pub. No.: US 2026/0290189 A1
(43) Pub. Date: Sep. 24, 2026

(54) SYSTEM

(71) Applicant: SoftBank Group Corp., Tokyo (JP)

(72) Inventor: Ko RYU, Tokyo (JP)

(73) Assignee: SoftBank Group Corp., Tokyo (JP)

(21) Appl. No.: 19/567,001

(22) Filed: Mar. 14, 2026

(30) Foreign Application Priority Data
Mar. 19, 2025 (JP) 2025-045014

(51) Int. Cl. G09B 7/02; G06N 3/0475; G10L 25/63

(52) U.S. Cl. CPC G09B 7/02; G06N 3/0475; G10L 25/63

(57) ABSTRACT

A system includes a processor that is configured to receive information via an interface for receiving information from a user, analyze the received information by using a natural language processing technique and evaluate a learning content and an emotional state of the user, and generate a prompt that instructs an individual adjustment of a learning plan of the user and a provision of an appropriate learning material based on an analysis result.

### CROSS-REFERENCE TO RELATED APPLICATION

This application is based on and claims priority under 35 USC 119 from Japanese Patent Application No. 2025-045014 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional computer-aided learning systems and online tutoring platforms generally provide a uniform learning plan and static teaching materials that are not sufficiently adapted to individual learners. Even when user input is accepted through an interface, such systems typically treat the input as simple commands or multiple-choice responses, and do not deeply analyze the semantic content or emotional state of the user. As a result, these systems are unable to dynamically adjust the learning plan, select optimal learning materials in real time, or tailor interactive dialogue in a manner that reflects both the learner's current understanding and emotional condition, such as frustration, boredom, or confusion.

Furthermore, known systems often generate reports that are limited to quantitative progress indicators, such as scores or completion rates, without automatically incorporating an analysis of the learner's emotional state. Such reports are not updated in real time as the learner's progress and emotional condition change, and therefore provide insufficient information for learners and stakeholders, such as parents and teachers, to understand the actual learning situation and to intervene appropriately.
Accordingly, there is a need for a system that can receive information from a user through an interface, analyze the information using natural language processing techniques to evaluate both the learning content and the emotional state of the user, and, based on the analysis results, (i) individually adjust the user's learning plan, (ii) provide appropriate learning materials, (iii) dynamically change dialogue content, and (iv) automatically update and notify report content reflecting the learning progress and emotional state of the user.

### SUMMARY

In order to solve the foregoing problems, a system according to one embodiment of the present invention comprises a processor, wherein the processor is configured to receive information via an interface for receiving information from a user, analyze the received information by using a natural language processing technique and evaluate a learning content and an emotional state of the user, and generate a prompt that instructs an individual adjustment of a learning plan of the user and a provision of an appropriate learning material based on an analysis result.

In this embodiment, the processor interprets user inputs that may include free-text queries, responses to questions, and conversational utterances, and applies natural language processing to extract semantic features related to the user's current learning topic, level of understanding, and emotional indicators such as expressions of confusion or frustration. On the basis of this evaluation, the processor generates a prompt that causes the system to modify the user's learning plan in an individualized manner, for example, by altering the order, difficulty, or type of tasks, and to select and provide learning materials that are most appropriate for the user's current state.
In another embodiment, the processor is configured to generate a prompt that dynamically changes a dialogue content in accordance with the learning content and the emotional state of the user. By doing so, the system can adapt its conversational behavior in real time, for example, by offering more detailed explanations when confusion is detected, providing encouragement when negative emotions are inferred, or accelerating progression when the user appears confident. This dynamic dialogue adaptation enables a more personalized and emotionally responsive tutoring experience.
In still another embodiment, the processor is configured to generate a prompt that automatically updates a report content in accordance with a learning progress and the emotional state of the user and notifies the user and stakeholders. Specifically, the processor continuously or periodically integrates the analysis results of the learning content and emotional state into a report structure, updates indicators such as topic-wise understanding, engagement level, and emotional trends, and triggers notifications or access updates so that the user, parents, teachers, or other stakeholders can view an up-to-date report. By combining learning progress and emotional state in an automatically updated report, the system provides richer and more actionable information to support timely and appropriate educational interventions.

The term “processor” refers to any hardware and/or software component, such as a central processing unit, microprocessor, microcontroller, or execution engine, that is capable of executing instructions to perform the functions described in the present specification and claims, including receiving, analyzing, and generating data or prompts.

The term “interface” refers to any hardware and/or software mechanism through which information is exchanged between the user and the system, including but not limited to graphical user interfaces, command-line interfaces, application programming interfaces, web interfaces, or input/output devices such as keyboards, touchscreens, microphones, and cameras.
The term “user” refers to any person who interacts with the system for the purpose of learning, including but not limited to students, trainees, or other learners, regardless of age, background, or learning environment.
The term “information” refers to any data or content provided by the user or otherwise obtained from the user through the interface, including natural language text, spoken utterances, answers to questions, selections in a user interface, behavioral signals, or other input relevant to the user's learning content or emotional state.
The term “natural language processing technique” refers to any algorithm, model, or computational method for processing and analyzing human language, including but not limited to tokenization, parsing, sentiment analysis, intent recognition, named entity recognition, semantic analysis, and machine learning or deep learning models for understanding or generating natural language.
The term “learning content” refers to the subject matter, topics, concepts, skills, or knowledge areas that the user is studying or to which the user's input relates, including, for example, mathematics, languages, science, or other academic or training domains.
The term “emotional state” refers to a psychological or affective condition of the user inferred from the user's input or behavior, including, for example, frustration, confusion, boredom, engagement, confidence, or motivation, as determined by the system using natural language processing or other analysis.
The term “learning plan” refers to a structured set of learning activities, goals, schedules, content sequences, difficulty levels, or strategies that define how the user should progress through one or more learning contents over time.
The term “individual adjustment” refers to a modification of the learning plan that is tailored to a specific user based on that user's learning content, performance, preferences, or emotional state, rather than a generic or uniform adjustment applied to multiple users.
The term “learning material” refers to any educational content or resource provided to the user to support learning, including but not limited to texts, problems, quizzes, videos, images, interactive exercises, or external resource links.
The term “appropriate learning material” refers to a learning material selected or determined by the system to be suitable for the user's current learning content, understanding level, and/or emotional state, such that it is expected to effectively support the user's learning at that moment.
The term “prompt” refers to any data, instruction, command, or control signal generated by the processor that causes another component, module, or system to perform a specific operation, including the adjustment of a learning plan, the provision of learning materials, the modification of dialogue content, or the updating and notification of report content.
The term “dialogue content” refers to the textual, spoken, or otherwise presented communicative content exchanged between the system and the user, including questions, explanations, feedback, encouragement, or other conversational elements.
The term “report content” refers to information included in a report generated or maintained by the system, such as indicators of learning progress, understanding level, topic coverage, emotional trends, timestamps, and summaries or visualizations of the user's learning activities and emotional state.
The term “learning progress” refers to a state or degree of advancement of the user's learning over time, as measured or inferred from factors such as completed tasks, scores, mastery of topics, time spent, and changes in understanding.
The term “stakeholders” refers to persons other than the user who have an interest in the user's learning situation, including but not limited to parents, guardians, teachers, tutors, school administrators, or other authorized parties.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

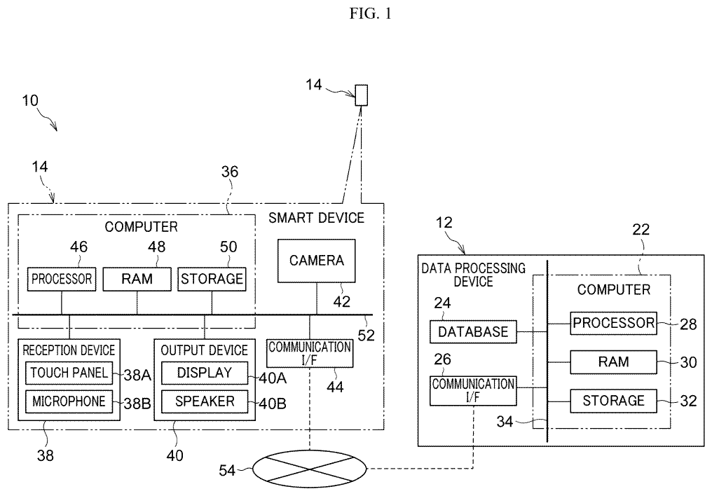

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

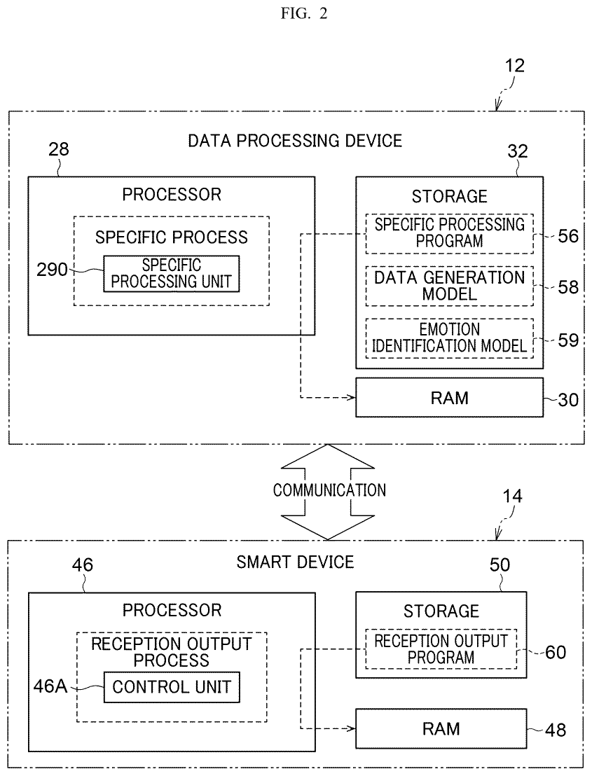

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented tutoring and learning-support systems typically rely on fixed rule sets, static dialog trees, or manually designed templates to generate explanations and study plans. In such systems, a processor usually applies predetermined logic to user input and then selects content from a limited repository of materials. As a result, these systems are unable to fully exploit large-scale generative AI models and cannot flexibly adjust the style, level, and structure of explanations on a per-user basis. This leads to several technical problems in the operation of the computer system itself.

First, the processor in conventional systems often treats user input as isolated events and does not maintain a unified representation of a learner state that integrates learning-history information, feedback information, and model analysis results. Consequently, the system cannot generate machine-readable conditions for controlling subsequent prompts to a generative AI model. This limitation forces repeated ad hoc prompt construction on the application side, increasing processing overhead and latency, and preventing systematic optimization of model behavior at run time.
Second, known systems do not treat the prompt sentence to a generative AI model as a first-class control signal that is iteratively optimized based on user feedback and historical performance. Instead, prompts are either fixed, or only superficially varied. This causes inefficient use of computational resources of the generative AI model, because the model must repeatedly infer user preferences and understanding level from scratch, rather than being guided by structured, machine-generated prompt-generation conditions. The absence of a feedback-driven prompt-control mechanism prevents the system from improving the quality and consistency of generated responses across multiple sessions.
Third, existing solutions do not provide a coherent mechanism by which the processor automatically generates learning-status report information, such as learning-progress information and understanding-degree information, in a format suitable for different recipients, including the user and related parties. The lack of such an automated report generation mechanism forces additional processing at the client side or by human operators, which increases system complexity and delays information delivery. Furthermore, the computer system cannot systematically reuse the analytical capabilities of the generative AI model to summarize and structure accumulated learning data.
Accordingly, there is a need for an improved computer-implemented learning-support system in which the processor (i) integrates received user information, learning-history information, and feedback information into learner-state information, (ii) converts that learner-state information into explicit prompt-generation conditions, and (iii) uses those prompt-generation conditions to control prompt sentences supplied to a generative AI model. By doing so, the system can reduce redundant computation, improve the efficiency and stability of generative AI model interactions, and enhance the adaptability and technical performance of the learning-support functions executed by the computer.

The specific processing by the specific processing unit 290 of the data processing device 12 in Example 1 is realized by the following means.

The present invention provides a server comprising a processor configured to receive, via an input/output device, information related to learning from a user; construct, based on the received information and stored learning-history information and feedback information, a first prompt sentence to be input to a generative AI model utilizing natural language processing, and supply the first prompt sentence to the generative AI model so as to cause the generative AI model to analyze an intention and an understanding level of the user and to generate learner-state information indicating a learning state for the user based on an analysis result; dynamically generate, in accordance with the learner-state information, a second prompt sentence that instructs the generative AI model to generate learning-response information customized for the user, and supply the second prompt sentence to the generative AI model so as to cause the generative AI model to generate the learning-response information; transmit the generated learning-response information to the input/output device so as to present the learning-response information to the user; acquire, via the input/output device, evaluation information or request information input by the user with respect to the learning-response information; analyze the evaluation information or the request information to update prompt-generation conditions for the user, the prompt-generation conditions including parameters relating to a degree of detail of explanation, a level of expression to be used, presence or absence of examples, and structure and amount of the explanation; and reflect the updated prompt-generation conditions in at least one subsequent prompt sentence to be supplied to the generative AI model so as to continuously optimize content and expression format of responses and to automatically generate learning-status report information including learning-progress information and understanding-degree information for notification to the user and related parties. This enables a computer-implemented learning-support system in which the processor systematically controls interactions with the generative AI model through machine-generated prompt sentences, thereby improving computational efficiency, stability, and personalization of generated responses, and enhancing the overall technical performance of the server in managing and adapting tutoring behavior over time.

The term “input/output device” refers to a hardware and/or software interface through which a user provides information to, and receives information from, the server, including but not limited to a terminal, a display device, a keyboard, a pointing device, a touch panel, a microphone, a speaker, or a network-connected client application.

The term “generative AI model” refers to a machine-implemented information-processing model that generates output data, including natural-language text, in response to input data, the model being trained on sample data and typically implementing a probabilistic or neural network architecture such as a language model, and being capable of performing natural language processing and response generation.
The term “prompt sentence” refers to a formatted sequence of characters, symbols, and/or structured fields supplied as input to the generative AI model, the sequence including instructions, constraints, user information, or context information that control or influence the content, style, or structure of output generated by the generative AI model.
The term “learning-history information” refers to data stored by the system that represents past learning-related interactions of a user, including but not limited to questions posed, responses presented, study topics, timestamps, performance results, and records of materials accessed.
The term “feedback information” refers to data that represents an evaluation, reaction, or request provided by the user or a related party with respect to generated responses or learning experiences, including but not limited to explicit ratings, free-text comments, selections of options such as “helpful” or “not helpful,” and other user-input signals indicative of satisfaction or desired changes.
The term “intention” refers to a meaning, goal, or purpose underlying user-provided information as inferred by the system or the generative AI model, including but not limited to a requested explanation, a request for practice problems, a request for additional detail, or an indication of confusion regarding a particular topic.
The term “understanding level” refers to an estimated degree of comprehension or proficiency of the user with respect to a subject matter, the degree being derived from learning-history information, feedback information, and/or analysis results from the generative AI model, and being usable to select or adjust the complexity or style of generated responses.
The term “learner-state information” refers to machine-readable data representing a current learning state of a user, the data including at least an intention and an understanding level, and optionally including subject-matter focus, recent topics, performance indicators, and preference indicators used by the processor to control subsequent processing.
The term “learning-response information” refers to output data generated by the generative AI model in response to a prompt sentence, the output data including at least one explanation, instruction, answer, hint, exercise, or other educational content that is customized for the user.
The term “evaluation information” refers to a subset of feedback information that explicitly or implicitly indicates a quality or usefulness of the learning-response information, including but not limited to ratings, satisfaction indicators, or textual assessments of clarity, level, or adequacy.
The term “request information” refers to a subset of feedback information that specifies a desired modification or additional requirement regarding learning-response information, including but not limited to requests for more detail, simpler explanations, more examples, or different presentation styles.
The term “prompt-generation conditions” refers to machine-readable parameters, rules, or configuration values that determine how the processor constructs prompt sentences for the generative AI model, the conditions including one or more items such as degree of detail, level of expression, presence or absence of examples, structure of explanation, and amount of explanation.
The term “degree of detail of explanation” refers to a parameter or set of parameters indicating a granularity of information to be included in generated learning-response information, such as whether the explanation should be high-level, step-by-step, or include intermediate reasoning steps and technical depth.
The term “level of expression” refers to a parameter indicating a linguistic complexity or technical level to be used in generated learning-response information, including but not limited to beginner, intermediate, and advanced levels, or their equivalents in terms of vocabulary and conceptual sophistication.
The term “presence or absence of examples” refers to a parameter indicating whether generated learning-response information should include illustrative examples, sample problems, analogies, or case descriptions, and optionally how many or what types of examples should be provided.
The term “structure and amount of the explanation” refers to one or more parameters that control the organizational format and length of generated learning-response information, including but not limited to use of sections, bullet points, enumerated steps, summary portions, and constraints on word count or token count.
The term “learning-status report information” refers to output data representing a summarized state of a user's learning over a period of time, the data including at least learning-progress information and understanding-degree information, and optionally including trends, strengths, weaknesses, and recommended next actions.
The term “learning-progress information” refers to data indicating how the user's learning has advanced over time, including but not limited to completed topics, time spent, correctness of answers, mastery states, and temporal progression of performance metrics.
The term “understanding-degree information” refers to data that quantifies or categorizes the user's comprehension or mastery level for one or more topics, the data being derived from analysis of user performance, learner-state information, and/or generative AI model output, and being representable as discrete levels, continuous scores, or descriptive labels.
The term “related party” refers to an entity other than the user that is authorized to receive learning-status report information, including but not limited to a teacher, guardian, administrator, or institution, and that may use such information for monitoring or supporting the user's learning activities.

In one embodiment, a server, a terminal, and a user cooperate to implement the claimed system. The server includes at least one processor, a memory, a nonvolatile storage device, and a network interface. The processor may be a general-purpose central processing unit, a graphics processing unit, or a specialized accelerator for machine-learning inference.

The memory may be a volatile memory device such as a dynamic random access memory. The storage device may be a magnetic disk drive or a solid-state drive. The network interface may be an Ethernet interface, a wireless local-area network interface, or a mobile-communication interface.
The terminal includes a processor, a memory, a display device, an input device, and a communication module. The terminal may be a smartphone, a tablet computer, a notebook computer, or a desktop computer. The input device may include a touch panel, a keyboard, a pointing device, or a microphone. The communication module may communicate with the server via a packet-switched network.
The server executes an application program stored in the storage device. The application program may be implemented using a general-purpose application server framework, such as a web application framework running on a server process. The server may employ a front-end web server component and an application runtime component. The server further accesses a data management system, such as a relational database management system stored on the storage device. The database management system stores learning-history information, feedback information, learner-state information, and prompt-generation conditions in predefined data structures.
The server stores the learning-history information in one or more tables or collections. A first table may store user identifiers, timestamps, question texts, topic identifiers, and response identifiers. A second table may store feedback entries, including ratings, free-text comments, and references to response identifiers. A third table may store prompt-generation conditions, including numeric parameters representing a degree of detail, a level of expression, a flag for presence or absence of examples, and length constraints for explanations. These data structures allow the server to access and update user-specific parameters efficiently by using indexed queries and in-memory caching.
The server deploys a generative AI model in the form of a trained neural network stored in the storage device. In one embodiment, the generative AI model is a transformer-based language model comprising multiple layers of self-attention blocks and feed-forward layers. The model parameters include weight matrices and bias vectors for each layer, embeddings for tokens and positions, and normalization parameters. The server loads the generative AI model into the memory and executes inference by applying sequences of matrix multiplications, nonlinear activation functions, and attention computations on the processor and/or on the graphics processing unit.
The server configures the generative AI model to operate on tokenized sequences of characters and words. The server applies a tokenizer to each prompt sentence and to each generated output. The tokenizer converts the prompt sentence into a sequence of token identifiers. The server then maps the token identifiers to embedding vectors, propagates these vectors through the transformer architecture, and obtains output probability distributions over token identifiers at each time step. The server determines an output sequence by applying a decoding algorithm such as greedy decoding or beam search, using parameters such as a temperature parameter or a maximum token length. These operations constitute concrete numerical computations that are optimized by vectorized operations and hardware acceleration.
The server stores an AI-inference module in the memory. The AI-inference module manages calls to the generative AI model, supplies prompt sentences, and collects output token sequences. The AI-inference module implements rules governing the construction of prompt sentences and the post-processing of output sequences. The AI-inference module is implemented as a component that exposes an internal programming interface to the application program, and encapsulates details of tokenization, decoding, and error handling. The server maintains a prompt-construction module that constructs prompt sentences in a rule-based and data-driven manner. The prompt-construction module refers to the learning-history information and feedback information retrieved from the database, and calculates prompt-generation conditions. For example, the prompt-construction module may calculate an average difficulty level by computing a weighted mean of performance scores associated with completed learning tasks. The prompt-construction module stores these numerical values as part of a user-specific record and uses them to determine whether the generative AI model should be guided toward simpler explanations or more advanced explanations.
The server uses non-conventional rules for constructing prompt sentences. The server does not simply mirror the user's input into a static template, but combines learned statistics and feedback-derived parameters. The server generates structured directives such as:
“You are an adaptive tutor for a learner with beginner-level understanding of calculus.
The learner asked: ‘Teach me the basic concept of differentiation.’
Explain the basic concept of differentiation in simple language.
Use short sentences and provide one intuitive real-world example.
Avoid heavy formulas unless necessary.”
In another example, the server generates a prompt sentence:
“You are a private tutor in university-level calculus.
The learner has consistently requested more detailed explanations.
The learner asks: ‘Please explain the derivative of x² in detail.’
Provide a step-by-step explanation using mathematical notation.
Show how the limit definition leads to the derivative, and describe the slope of the tangent line on a graph.
Assume the learner knows basic algebra but is new to calculus.”
The server constructs such prompt sentences by concatenating fixed instruction segments with variable segments derived from the learner-state information and the prompt-generation conditions. The variable segments are generated by applying preconfigured mapping rules that convert numeric difficulty levels and flags into natural-language instructions. This mapping is performed by deterministic logic executed by the processor, not by the generative AI model, and therefore yields predictable, machine-controlled modifications of the prompt sentences.
The server uses the generative AI model as a computational engine that performs numerical optimization of probability distributions over token sequences based on the prompt sentence.
The server uses the analysis capability of the generative AI model to infer a topic, an intention, and an approximate understanding level from the raw user input. In one embodiment, the server specifies the following analysis-oriented prompt sentence: “Analyze the following learner question: ‘Teach me the basic concept of differentiation.’ Return a topic, an intent type, and a rough complexity level (beginner, intermediate, or advanced).
Respond in the format:
Topic: . . . .
Intent: . . . .
Complexity: . . . . ”
   The server treats the output of this analysis as structured data and parses it according to delimiters. The server thereby converts unstructured natural-language output into structured learner-state information. This approach provides a non-conventional, programmatic use of the generative AI model, turning the model into a tool to build and refine internal data structures rather than merely generating text for human consumption.
   The server updates the prompt-generation conditions in response to feedback information. When the terminal transmits user feedback such as “I want a more detailed explanation with formulas and graphs,” the server stores this text and an associated rating value in the feedback table. The server then executes a feedback-analysis algorithm that classifies the feedback into categories. The server may apply a lightweight classifier or may supply the feedback text to the generative AI model using a specific prompt sentence such as:
“Classify the following feedback into one or more of: ‘needs more detail’, ‘needs simpler explanation’, ‘needs more examples’, ‘satisfied’.
Feedback: ‘I want a more detailed explanation with formulas and graphs.’
Output only the labels.”
   The server parses the resulting labels and increments counters associated with corresponding parameters in the prompt-generation conditions. For example, when the feedback is classified as “needs more detail,” the server increases a numeric parameter representing the degree of detail for that user. The server stores these updated parameters in the database and caches them in memory for future interactions. This iterative, machine-controlled feedback loop is not equivalent to manual editing of prompts; it is a systematic, programmatic approach that modifies the internal configuration of the server and affects subsequent computational behavior of the generative AI model.
   The server employs specific data structures to implement this behavior. In one embodiment, a prompt-condition record contains fields for a user identifier, a difficulty score, a detail level, an expression-level code, an example-flag bit, and a maximum length parameter. The server updates these fields by applying integer increments, decrements, and bounded clipping operations in response to feedback classifications. The server then uses these fields in the prompt-construction module, which applies branching logic to assemble the next prompt sentence. This architecture enables efficient data access and update operations and allows the server to scale to a large number of users while maintaining per-user customization.
   The server controls the flow of data between the terminal and the generative AI model to reduce unnecessary data transfer and computation. The server caches learner-state information and prompt-generation conditions in memory for users with recent activity. When a new user input is received, the server retrieves these cached structures instead of recomputing them from scratch. The server thus avoids re-sending redundant context to the generative AI model. This caching strategy reduces network traffic between the application layer and any remote inference service, reduces the number of tokens processed by the generative AI model, and improves response time.
   The server configures the generative AI model's hyperparameters adaptively based on the type of task. For example, the server reduces the temperature parameter and narrows the sampling range when generating structured reports, in order to produce more deterministic outputs that are easier to parse into data fields. The server may increase the temperature for open-ended explanatory responses to allow more diverse phrasing. The server stores these hyperparameter choices in conjunction with the prompt-generation conditions so that the application can consistently enforce them across sessions. This non-conventional combination of prompt-sentence construction and hyperparameter control improves the stability and machine-parsability of the model outputs, which is a technical improvement over naive, single-purpose use of generative models.
   The server uses the generative AI model not only to generate explanations but also to generate learning-status report information. The server constructs a report-generation prompt sentence such as:
   “You are generating a learning report for a learner.
   Summarize the learner's recent progress in calculus, based on the following data:
Topics practiced: . . .
Correctness rate: . . .
Feedback summary: often requests more detailed explanations.
   Describe the learner's current understanding level and suggest next topics.
   Use a concise, structured format with headings ‘Progress’, ‘Current Level’, and ‘Next Steps’.”
   The server assembles the data section of this prompt sentence by retrieving and aggregating learning-history information from the database. The server then supplies the prompt sentence to the generative AI model and obtains a structured natural-language report. The server may further parse headings or markers in the report to store portions of the report as separate fields in the database. The server then transmits the report text to the terminal of the user and, where appropriate, to a terminal of a related party. This reuse of the generative AI model's text-generation capability reduces the need for bespoke reporting logic and leverages the model's capacity to organize complex data into human-readable summaries.
   The server achieves technical advantages through these specific mechanisms. Because the server converts user interactions and feedback into machine-readable prompt-generation conditions, the server can optimize the length and structure of prompt sentences. This reduces the number of tokens supplied to the generative AI model and thereby reduces computational load and latency. Because the server maintains learner-state information and reuses it across sessions, the server avoids repeated inference of the same user characteristics, improving efficiency. Because the server systematically controls hyperparameters and uses deterministic prompt templates for analysis and reporting, the server obtains more stable and machine-parsable outputs, which reduces error rates in downstream parsing and storage modules.
   The server implements the generative AI model using a specific neural-network architecture and training method. In one embodiment, the generative AI model is trained using a large corpus of text data. The training process minimizes a loss function such as cross-entropy between predicted token distributions and observed tokens in the corpus. The training process adjusts the model weights by applying an optimization algorithm such as stochastic gradient descent or a variant thereof. The server uses the trained model for inference only, but the specification of the architecture and training process ensures that the model has the capability to generalize across learning topics and produce coherent text. The server may additionally fine-tune the model using domain-specific educational data so that the model provides more accurate and pedagogically appropriate explanations.
   The server may implement alternative embodiments. In one alternative embodiment, the server executes the generative AI model entirely on a local graphics processing unit. In another alternative embodiment, the server communicates with an external inference service that hosts the generative AI model, using a secure application programming interface. In another variant, the server combines outputs from a main generative AI model and a smaller auxiliary classifier model to refine learner-state information. In yet another variant, the server uses a non-neural generative model with probabilistic mechanisms but still constructs and controls prompt sentences as described.
   The terminal interacts with the server by sending and receiving structured messages. The terminal provides an interface where the user can input questions and feedback and where the terminal displays the learning-response information and the learning-status report information. The terminal may locally store temporary copies of responses and may pre-process user inputs (for example, by checking character limits) before transmitting them to the server. However, the main intelligence and adaptation logic reside in the server. The user operates the terminal to ask questions, review explanations, and provide feedback. The user is not required to understand the internal mechanisms of the generative AI model or the prompt-construction logic. The system transparently adjusts explanations and reports over time. The user experiences improved response relevance, clearer explanations aligned with the user's understanding level, and more informative reports.
   Through these embodiments, the server, the terminal, and the user cooperate to realize a system that goes beyond simple automation of human tutoring. The server modifies its internal data structures and control signals (prompt-generation conditions and prompt sentences) in response to measurable feedback. This modification leads to improved computational efficiency, reduced communication load, and enhanced accuracy and stability in the output of the generative AI model. As a result, the system achieves a technical improvement in the operation of computer hardware and software that implement adaptive learning support.

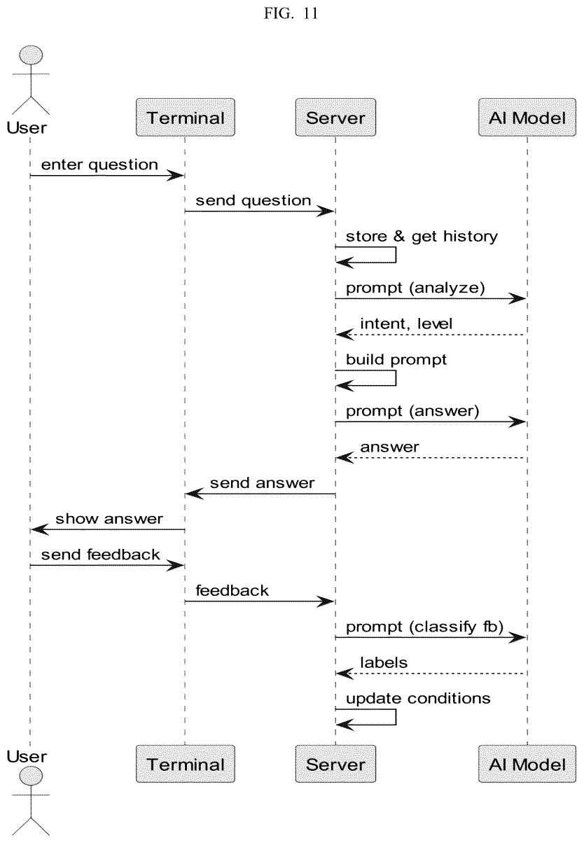

The following describes the processing flow using FIG. 11.

### Step 1:

The user operates the terminal to launch a learning application and view an input screen.
The user inputs a learning-related question as text, such as “Teach me the basic concept of differentiation,” and then triggers a send operation.
The terminal receives the text input as a character string, attaches metadata such as a user identifier, a timestamp, and device information, and validates that the text is not empty and does not exceed a predefined length.
The terminal converts the validated input into a structured internal object and transmits this object to the server via a network connection using a communication protocol.
The input of this step is the raw question text and user-related metadata; the output of this step is a structured request message sent from the terminal to the server.

### Step 2:

The server receives the structured request message from the terminal through a network interface and passes it to an application module.
The server parses the message to extract fields such as the user identifier, the question text, and the timestamp, and verifies the integrity of the data.
The server stores the question text and the associated metadata into a persistent data structure in a database, creating a new question record and assigning it a unique identifier.
The server may perform basic preprocessing on the question text, such as normalization of character encoding and removal of unwanted control characters.
The input of this step is the structured request message; the output of this step is a stored question record and a normalized question text accessible for further processing.

### Step 3:

The server queries a database using the user identifier to retrieve learning-history information and feedback information for the user.
The server obtains records such as past questions, correctness scores, difficulty levels, and previously stored feedback classifications.
The server performs data operations on these records, including aggregating scores, counting occurrences of particular feedback categories (for example, “needs more detail”), and calculating summary statistics such as an average difficulty level.
The server synthesizes these results into learner-state information, including an estimated understanding level and preference parameters, and stores this learner-state information in memory.
The input of this step is the user identifier and associated database records; the output of this step is learner-state information that characterizes the user's current learning status.

### Step 4:

The server constructs a first prompt sentence for analysis by combining the normalized question text and the learner-state information with predefined instruction segments.
The server concatenates strings representing system instructions (for example, “Analyze the following learner question”), the user's actual question, and formatting markers that will allow structured output parsing.
The server applies deterministic mapping rules that translate numeric difficulty scores and preference flags into descriptive natural-language phrases inserted into the prompt sentence.
The input of this step is the normalized question text and the learner-state information; the output of this step is a text-based analysis-oriented prompt sentence ready to be supplied to the generative AI model.

### Step 5:

The server supplies the analysis-oriented prompt sentence to the generative AI model through an AI-inference module.
The server tokenizes the prompt sentence into a sequence of tokens and converts these tokens into numeric identifiers as required by the generative AI model.
The server forwards the token identifiers to the generative AI model, which performs internal computations such as embedding lookup, attention-weight calculation, and matrix multiplications across multiple layers of a neural-network architecture.
The server receives an output sequence or formatted text from the generative AI model that indicates at least a topic, an intent, and a complexity classification for the question.
The input of this step is the analysis-oriented prompt sentence; the output of this step is structured or semi-structured analysis information describing the intention and complexity for the user's question.

### Step 6:

The server parses the analysis information by searching for predefined labels and delimiters (for example, “Topic:”, “Intent:”, “Complexity:”) and extracting the corresponding values. The server converts these textual values into standardized codes or enumerations, such as numerical codes for topic identifiers and discrete categories for complexity levels.
The server integrates these codes with the previously constructed learner-state information, updating fields that represent the current topic focus and the detected request type.
The server stores the updated learner-state information in memory and may also update the corresponding database record for the question.
The input of this step is the raw analysis output from the generative AI model; the output of this step is refined learner-state information and standardized analysis codes.

### Step 7:

The server constructs a second prompt sentence for answer generation based on the refined learner-state information and analysis codes.
The server selects sentence templates according to the user's understanding level, preference parameters, and detected intent, and fills template slots with the actual question text and user-specific guidance.
The server may embed explicit constraints such as target length, explanation style, and presence of examples, by incorporating phrases like “Explain in simple language” or “Provide a step-by-step derivation with formulas.”
The input of this step is the refined learner-state information and the question text; the output of this step is an answer-generation prompt sentence tailored to the individual user.

### Step 8:

The server supplies the answer-generation prompt sentence to the generative AI model using the AI-inference module.
The server tokenizes the prompt, maps tokens to embeddings, and invokes the generative AI model with specific inference parameters such as temperature, maximum token length, and decoding strategy.
The generative AI model generates a sequence of output tokens, which the server decodes to form a natural-language explanation or other educational content.
The server performs post-processing on the generated text, such as trimming excessive length, inserting paragraph breaks, or converting special markers into formatting elements.
The input of this step is the answer-generation prompt sentence; the output of this step is learning-response information in the form of a text explanation adapted to the user.

### Step 9:

The server encapsulates the learning-response information along with metadata such as the question identifier, topic code, and generation timestamp into a response message.
The server transmits this response message to the terminal via the network interface using the established communication protocol.
The server may record a log entry containing the response length, processing time, and identifiers for subsequent monitoring and analysis.
The input of this step is the post-processed learning-response information; the output of this step is a structured response message sent from the server to the terminal.

### Step 10:

The terminal receives the response message from the server and parses the contained data fields.
The terminal extracts the learning-response information and applies display formatting suitable for the device, such as breaking the text into lines or adding headings.
The terminal presents the formatted learning-response information on the display device so that the user can read and interact with the explanation.
The input of this step is the structured response message; the output of this step is the visual presentation of the learning-response information to the user.

### Step 11:

The user reads the displayed learning-response information and evaluates its usefulness, clarity, and level.
The user provides feedback via the terminal by selecting options (for example, rating buttons) or entering free-text comments such as “I want a more detailed explanation with formulas.”
The terminal captures the feedback input along with identifiers for the corresponding question and response and packages this data into a feedback message.
The terminal transmits the feedback message to the server through the communication module.
The input of this step is the user's subjective evaluation and comments; the output of this step is a structured feedback message sent to the server.

### Step 12:

The server receives the feedback message and parses it to extract fields such as a rating value, feedback text, and associated question identifier.
The server stores the feedback information in a dedicated feedback record in the database, linking it to both the user identifier and the question identifier.
The server optionally constructs a classification-oriented prompt sentence that embeds the feedback text and instructions for the generative AI model to label the feedback into predefined categories.
The input of this step is the structured feedback message; the output of this step is a stored feedback record and, when applicable, a classification-oriented prompt sentence for further analysis.

### Step 13:

The server supplies the classification-oriented prompt sentence to the generative AI model via the AI-inference module and obtains classification labels that indicate aspects such as “needs more detail” or “needs simpler explanation.”
The server parses the labels, maps them to internal parameter adjustments, and updates prompt-generation conditions associated with the user, such as increasing a detail-level parameter or toggling an example-inclusion flag.
The server writes the updated prompt-generation conditions back to the database and refreshes any cached in-memory structures that hold these conditions.
The input of this step is the stored feedback text and any classification results; the output of this step is a set of updated prompt-generation conditions for the user.

### Step 14:

The server uses the updated prompt-generation conditions in subsequent interactions when constructing analysis-oriented and answer-generation prompt sentences for that user.
The server thereby modifies the content and style of future prompts by, for example, explicitly requesting more examples or more detailed derivations, leading to different computational behavior in the generative AI model.
The server maintains a consistent association between user identifiers, learner-state information, feedback history, and prompt-generation conditions, enabling a persistent adaptive profile.
The input of this step is the updated prompt-generation conditions; the output of this step is a modified prompt-construction process that affects all future learning-response information generated for the same user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented learning support systems primarily rely on static rules or simple recommendation logic that select learning materials based on coarse indicators such as past scores or completed lessons. Such systems typically treat user inputs as keywords rather than rich natural language expressions, and therefore fail to accurately capture a user's learning intention, current proficiency, and nuanced learning context. As a result, the systems frequently provide suboptimal content sequences, inappropriate difficulty levels, and generic feedback, which reduces learning efficiency and user engagement. Furthermore, in many existing systems, the generation of explanations, exercises, and feedback reports is implemented as fixed templates or pre-authored content. This rigid structure limits the system's ability to adapt in real time to changes in the user's proficiency, emotional state, and learning progress. From a computer technology standpoint, these systems underutilize available data and computing resources, and they do not provide an effective mechanism to coordinate natural language processing, machine learning inference, and generative models in a unified, dynamically reconfigurable pipeline.

In addition, while generative artificial intelligence models have become available as powerful tools for generating natural language content, conventional learning systems often invoke such models in an ad hoc manner, without a structured and machine-optimized mechanism to construct prompt sentences based on internal state data such as learning history, comprehension indices, and strategy parameters. This leads to inconsistent output quality, redundant computation, and difficulty in reliably controlling the behavior of the generative models, thereby limiting the technical robustness and scalability of the overall system. Moreover, existing architectures generally lack an integrated feedback loop that automatically updates user-specific learning history information and comprehension indices, and then reconfigures subsequent prompts and content generation behavior in response to the updated state. Without this closed-loop control, the system cannot continuously refine its internal models or dynamically adjust content generation in a way that optimizes computational resource usage and response quality over time.
Accordingly, there is a need for an improved computer-implemented learning support system that: (i) systematically analyzes natural language learning requests to derive structured learning target and intention data; (ii) computes user-specific comprehension indices using machine learning models operating on feature data derived from learning history; (iii) constructs data-driven prompt sentences for generative artificial intelligence models in a controlled and repeatable manner; and (iv) maintains a continuous, automated feedback loop that updates internal state and reconfigures content generation and dialogue behavior. Such improvements would not merely automate educational processes, but would materially enhance the functioning of the computer system itself by enabling more efficient data processing, better coordinated use of heterogeneous models, and more reliable, context-aware generation of learning content and reports.

The specific processing by the specific processing unit 290 of the data processing device 12 in Application Example 1 is realized by the following means.

The present invention provides a server comprising at least one processor, a communication apparatus, a storage apparatus configured to store learning history information, and access to a generative artificial intelligence model, the at least one processor being configured to execute computer-executable instructions that cause the server to receive, via the communication apparatus, learning request information expressed in natural language from a user terminal; to analyze the natural language learning request information using a natural language processing technique to identify at least a learning target domain, a learning intention, and an indication of a learning proficiency level; to acquire, from the storage apparatus, learning history information associated with the user and to generate feature data representing the user's learning state; to apply a machine learning model to the feature data together with the identified learning target domain in order to compute at least one comprehension index quantifying the user's understanding for one or more concepts; to determine learning strategy information by selecting a learning method, a content type, and a content difficulty level based on the comprehension index and the learning intention; to construct a first prompt sentence for the generative artificial intelligence model, the first prompt sentence being automatically composed from structured condition information including the learning history information, the comprehension index, and the learning strategy information; to provide the first prompt sentence as input to the generative artificial intelligence model and to obtain, as structured data, generated learning content information including at least explanation information, exercise information, and evaluation information; to select, based on the generated learning content information and the learning strategy information, content information to be presented to the user and to transmit the selected content information to the user terminal via the communication apparatus; to receive learning result information from the user terminal, the learning result information indicating user responses and performance with respect to the presented content; to update the learning history information and to recompute the comprehension index based on the learning result information; to generate learning report information corresponding to the updated learning state; and to construct a second prompt sentence for the generative artificial intelligence model, the second prompt sentence including the learning report information and being used to cause the generative artificial intelligence model to generate a natural language explanatory text serving as a learning report or feedback message. This enables a technically improved, closed-loop learning support system in which the server dynamically coordinates natural language processing, machine learning inference, and generative content generation through structured, data-driven prompt construction and state updating, thereby enhancing the efficiency, adaptability, and controllability of computer-based learning content generation and user interaction.

The term “processor” refers to one or more hardware information processing units, such as a central processing unit or a specialized computation unit, configured to execute computer-executable instructions to perform the functions described herein.

The term “communication apparatus” refers to one or more hardware and software components configured to enable data exchange between the server and external devices, including user terminals, over wired or wireless communication networks.
The term “learning history information storage apparatus” refers to one or more storage devices, such as non-transitory computer-readable media, configured to store structured records of user learning activities, including past content accesses, assessment results, timestamps, and related metadata.
The term “generative artificial intelligence model” refers to a computational model, such as a parameterized statistical model or neural network, configured to generate output data including natural language text or structured content in response to input conditions or prompt sentences.
The term “learning request information” refers to data representing a user's request related to learning, including a natural language expression that indicates at least a desired subject, topic, scope, or learning objective.
The term “natural language processing technique” refers to one or more algorithms or procedures that analyze text expressed in human language in order to extract structured information such as topics, intents, entities, and relationships.
The term “learning target domain” refers to a classification of a subject area or topic that is the focus of a user's learning request, such as a particular academic field, concept group, or skill category.
The term “learning intention” refers to information indicating a user's goal or purpose in a learning request, including desired depth, pace, starting level, or specific outcomes such as review, practice, or advanced study.
The term “learning proficiency level” refers to an indication of the user's current capability or familiarity with respect to a given learning target domain, represented qualitatively or quantitatively, and derived from user input, history, or model estimation.
The term “learning history information” refers to stored digital records describing a user's past interactions with learning content, including completed lessons, test or quiz results, time spent, content identifiers, and progress states.
The term “feature data” refers to numerical or categorical values computed from raw learning history information and related data, and formatted as input to a machine learning model for estimation or prediction.
The term “machine learning model” refers to a parameterized computational model trained on example data to learn relationships between inputs and outputs, and configured to perform inference to produce predictions, such as comprehension indices, from feature data.
The term “comprehension index” refers to a numerical or structured indicator generated by a machine learning model that quantifies a user's understanding or mastery of one or more concepts or topics within a learning target domain.
The term “learning strategy information” refers to structured data specifying a planned configuration of learning conditions, including at least a selected learning method, a content type, a content difficulty level, and optionally sequencing or pacing parameters.
The term “learning method” refers to an approach or modality for presenting learning content, such as expository explanation, example-based instruction, practice exercises, quizzes, or mixed modes.
The term “content type” refers to a classification of learning materials based on format, such as textual explanation, problem set, quiz, interactive exercise, audiovisual content, or summary.
The term “content difficulty level” refers to a representation of the complexity or challenge associated with learning content, categorized or scaled to match user comprehension indices or proficiency levels.
The term “condition information” refers to structured data used to define the input context of a generative artificial intelligence model, including at least learning history information, comprehension indices, and learning strategy information.
The term “prompt sentence” refers to a textual or equivalent representation of instructions, context, and constraints provided as input to a generative artificial intelligence model to control or guide the content of the model's output.
The term “learning content information” refers to data, generated by the generative artificial intelligence model, that specifies or contains learning materials such as explanations, exercises, assessments, or related educational elements.
The term “explanation information” refers to text or other descriptive content that explains concepts, procedures, or principles relevant to the learning target domain.
The term “exercise information” refers to data describing practice activities or problems intended for user engagement, including questions, tasks, or scenarios that reinforce or test understanding.
The term “evaluation information” refers to data used to assess user performance or understanding, including correct answers, scoring rules, solution steps, or criteria for grading.
The term “content information” refers to selected learning content, including at least a subset of learning content information and associated metadata, prepared for presentation to a user.
The term “user terminal” refers to an electronic device operated by a user, such as a personal computer, smartphone, or tablet device, configured to communicate with the server and present learning content and interfaces.
The term “learning result information” refers to data acquired from the user terminal indicating the user's responses, performance metrics, interaction history, or completion status with respect to presented learning content.
The term “learning report information” refers to structured data summarizing a user's learning status, progress, strengths, weaknesses, and recommended next steps, produced based on updated learning history information and comprehension indices.
The term “explanatory text” refers to a natural language narrative or message generated by a generative artificial intelligence model to present learning report information, feedback, or guidance to a user or related party.
The term “dialogue content” refers to sequences of natural language exchanges between the system and a user, including questions, responses, prompts, and feedback messages that support interactive learning.
The term “learning progress information” refers to data indicating temporal or sequential aspects of the user's learning activities, including progress through content, change in performance over time, and completion status of planned learning steps.
The term “report content” refers to the substantive elements of a learning report, including evaluated results, analysis of comprehension, recommendations, and summaries of past and future learning activities.
The term “recommended learning items” refers to specific units of learning content or topics that are suggested to the user for future study based on learning result information and comprehension indices.
The term “subsequent learning plan” refers to structured information defining a future learning schedule or pathway, including ordered topics, suggested content types, and timing or frequency of learning sessions.
The term “related party” refers to an entity other than the user, such as an instructor, guardian, or administrator, that is authorized to receive learning reports or progress information generated by the system.

In one embodiment, a server executes a computer program on one or more processors to implement the claimed system. The server includes a central processing unit, a main memory, a non-volatile storage device, and a communication interface connected to a network. The server cooperates with one or more terminals operated by a user, such as a smartphone, a tablet, or a personal computer, each including a display unit, an input unit, and a communication module.

The server stores, in the non-volatile storage device, a learning management module, a natural language processing module, a feature generation module, a machine learning inference module, a generative content orchestration module, and a reporting module. The server also stores learning history information in a structured data repository implemented, for example, as relational tables in a database management system. The server may use a general-purpose operating system, a web application framework, a numerical computation library, a natural language processing library, and a machine learning library to execute the program modules.
The server uses the natural language processing module to process incoming natural language expressions received from the terminal. The server converts each received text into internal data structures, such as token sequences, part-of-speech tag sequences, dependency graphs, and vector embeddings. The server may use a tokenization algorithm to segment the text into tokens, a part-of-speech tagging algorithm based on a probabilistic model, and a dependency parsing algorithm based on a graph-based or transition-based parser. The server then uses these structures to identify candidate topic terms, verbs expressing learning actions, modifiers indicating level or scope, and other syntactic or semantic features.
The server uses the feature generation module to transform learning history information and analysis results into numerical feature data suitable for machine learning inference. The server stores learning history information as records including user identifiers, content identifiers, timestamps, scores, completion flags, time-on-task, and difficulty level tags. The server aggregates these records per topic or concept and computes statistical features such as mean scores, score variances, counts of completed items, moving averages over recent sessions, and time decay factors. The server may represent these features as fixed-length vectors for each user and topic.
The server uses the machine learning inference module to compute a comprehension index for one or more concepts within a learning target domain. In one embodiment, the server implements a feed-forward neural network model with an input layer corresponding to the feature vector, one or more hidden layers with non-linear activation functions, and an output layer producing continuous values between zero and one for each concept. The server may use a rectified linear unit function or another non-linear function in the hidden layers, and may apply a sigmoid or softmax function in the output layer. The server uses stored model parameters obtained by prior training and performs forward propagation for each feature vector to obtain comprehension indices.
The server, during training of the neural network model, applies a supervised learning method using labeled training data that includes historical feature vectors and corresponding ground-truth comprehension labels. The server defines a loss function such as mean squared error or cross-entropy between the predicted indices and the labels, and updates model weights using a gradient-based optimization algorithm such as stochastic gradient descent or an adaptive gradient method. The server may perform mini-batch training, apply weight regularization, perform early stopping based on validation performance, and use data augmentation in the feature space by perturbing or resampling historical features to improve generalization. As a result, the trained model provides more accurate and stable comprehension indices than simple rule-based or linear methods, thereby improving the precision of subsequent content selection and reducing repeated, unnecessary content delivery.
The server uses the learning strategy information to coordinate the behavior of the generative artificial intelligence model and the selection of pre-existing content. The server generates learning strategy information by combining the comprehension index values with the identified learning intention and target domain. For example, when the comprehension index for a basic concept is below a threshold, the server assigns a strategy label such as “remedial explanation” or “introductory sequence.” When the comprehension index lies in an intermediate range, the server assigns a strategy label such as “practice-heavy sequence,” and when the index is high, the server assigns an “advanced challenge” strategy. The server encodes these strategy labels, together with content type preferences and difficulty ranges, into a structured representation that is used for both prompt construction and filtering of candidate content items.
The server uses the generative content orchestration module to construct prompt sentences for the generative artificial intelligence model. The server generates a prompt sentence by concatenating a system instruction segment, a user context segment, and a task specification segment, each derived from internal structured data. The server converts the learning history information, comprehension indices, and strategy parameters into natural language statements and inserts them into the prompt sentence in predefined template positions. By doing so, the server transforms machine-oriented state information into a form that the generative model can interpret, while maintaining deterministic control over the inclusion and ordering of key state variables.
For example, the server may generate a prompt sentence such as:
“You are an intelligent tutoring system. The user wrote: ‘I want to learn differential and integral calculus from the basics.’
The analyzed topic is calculus, with subtopics: limits, derivatives, integrals.
The user's understanding scores are: limits=0.3, derivatives=0.4, integrals=0.2. Based on this information, generate a learning plan for a beginner including:
1) a short explanation of the fundamental concepts,
2) three example problems with step-by-step solutions, and
3) five quiz questions with correct answers. Use simple English and keep the total output within 800 words.”
   In another example, the server may generate a feedback-oriented prompt sentence such as: “You are a learning coach. The user has just completed a calculus practice session.
   The results are: 8 correct answers out of 10 on basic derivatives, average response time 45 seconds, and previous score was 5 out of 10.
   The user's updated understanding scores are: limits=0.5, derivatives=0.7, integrals=0.3. Based on this data, generate a concise feedback message in simple English that:
1) praises the user's improvement in derivatives,
2) explains that integrals still require more practice, and
3) suggests the next two topics to study.”
   The server passes such prompt sentences, as text, to the generative artificial intelligence model. In one embodiment, the server accesses a neural network-based generative model implemented as a sequence-to-sequence architecture with an encoder-decoder structure and an attention mechanism, or as a transformer-based model composed of multiple self-attention layers and feed-forward sublayers. The server provides the prompt tokens as input to the model, which computes, at each layer, attention-weighted representations by applying linear transformations, softmax operations, and non-linear activations. The server controls model behavior by specifying parameters such as temperature, top-k or top-p sampling thresholds, maximum token length, and presence or frequency penalties at inference time.
   The server, by constructing prompt sentences in a structured, data-driven fashion, reduces variability in model behavior and ensures that the generative artificial intelligence model uses consistent internal context for similar states. This coordination improves the reproducibility and reliability of generated content and reduces the need for repeated trial-and-error prompts. Technically, the server reduces the number of network calls and inference operations required to obtain suitable content, improving processing throughput and lowering communication and computation load.
   The server receives generated text output from the generative artificial intelligence model and uses the generative content orchestration module to parse and structure the output. The server may instruct the model to insert headings or numbered sections, and then uses delimiter detection and pattern recognition to divide the text into explanation sections, example problem sections, and quiz sections. The server maps these sections into internal content records with fields identifying the type, the associated concept, an estimated difficulty level, and an estimated time requirement. The server subsequently stores these records in the learning history information storage apparatus, linked to the user and the originating prompt, enabling auditing, reuse, and version management.
   The server selects content information to be presented to the user by applying filtering and ranking operations on both generated and pre-existing content items. The server uses the learning strategy information and comprehension indices as constraints and scoring factors. For example, the server may enforce a rule that prevents selection of advanced items when the comprehension index is below a threshold, or may prioritize content with concept coverage complementary to past exposures. By using numerical scores and content metadata, the server dynamically composes a learning sequence that aligns with the current state, thereby reducing redundant content and decreasing user dropout risk.
   The terminal receives the selected content information via the communication interface. The terminal converts structured content records into display elements, such as paragraphs of text, graphical representations of formulas, multiple-choice panels, or input fields for free-form answers. The user interacts with these elements by reading explanations, solving problems, and entering answers. The terminal records user actions, such as selected choices, response times, number of attempts, and early exits, and transmits this learning result information back to the server.
   The server uses the learning result information to update learning history information and to recompute feature data and comprehension indices. The server appends new records to the learning history tables, updates aggregate statistics, and re-executes the feature generation and machine learning inference modules. Because the server maintains a closed-loop pipeline, updated comprehension indices directly influence subsequent prompt construction and content selection. As a result, the system adapts not only at the level of content sequence but also at the level of prompt design for the generative artificial intelligence model, which is a non-traditional, computer-centric optimization that a human tutor would not easily replicate manually.
   The server uses the reporting module to generate learning report information and corresponding explanatory text. The server composes report data structures that include updated comprehension indices per topic, summary statistics of recent performance, comparison to prior sessions, and recommended future content. The server then constructs a report-oriented prompt sentence encoding this data. The generative artificial intelligence model produces a natural language report that interprets the numerical and structural data into an accessible narrative. By embedding numerical values and structural annotations directly into the prompt sentence, the server ensures that the generated text accurately reflects the internal state, reducing misalignment between system data and user-visible feedback.
   The server, by integrating natural language processing, numerical feature computation, machine learning inference, and controlled generative content creation, improves computer technology in several ways. The server reduces the amount of data that must be transmitted between modules by converting raw histories into compact feature vectors before inference. This conversion lowers memory usage and reduces the computational complexity of subsequent model evaluations. The server also improves latency by pre-loading models and reusing intermediate representations for multiple requests from the same user. Because the prompt sentences are generated from structured data, the server minimizes unnecessary variability and reduces the number of generative calls required to reach an acceptable output, thereby enhancing throughput on shared computational resources.
   The server performs processing steps and model orchestration according to rules and algorithms that are distinct from human manual operations. For example, the server uses explicit thresholds and non-linear mappings between comprehension indices and strategy states, applies content selection algorithms based on multi-criteria scoring, and constructs prompt sentences via deterministic templates and conditional insertion of state variables. The server additionally uses training-time optimizations such as batch processing, vectorized operations, and hardware acceleration, which contribute to lower error rates and faster convergence of the machine learning model compared to naive or purely manual tuning. In alternative embodiments, the server may replace the feed-forward neural network with a recurrent neural network, a transformer encoder, or an ensemble of models. The server may incorporate additional feature types such as temporal sequence embeddings, attention-based weights over past sessions, or clustering indicators. The server may implement the generative artificial intelligence model locally on hardware accelerators, or may access a remote model via an application programming interface. In each case, the server retains the structured, state-driven prompt construction mechanism and the closed-loop update process of learning history and comprehension indices.
   In another embodiment, the server may adjust the internal parameters of the content selection logic based on observed performance at the system level. The server may, for example, monitor whether particular strategies consistently lead to high error rates or slow progress and then adjust threshold values or weightings in the scoring functions. Because these adjustments occur through numeric optimization routines and data-driven analysis within the server, they constitute technical refinements of the computer-based decision process, not mere changes in human policy.
   Through these embodiments, the server, the terminal, and the user cooperate in a technical system that not only automates educational workflows but also enhances the underlying computational processes of analysis, inference, and content generation. The server improves processing speed, reduces communication overhead, increases the accuracy of comprehension estimation, and stabilizes the behavior of the generative artificial intelligence model by using structured, data-driven prompt sentences and a tightly integrated, model-based feedback loop.

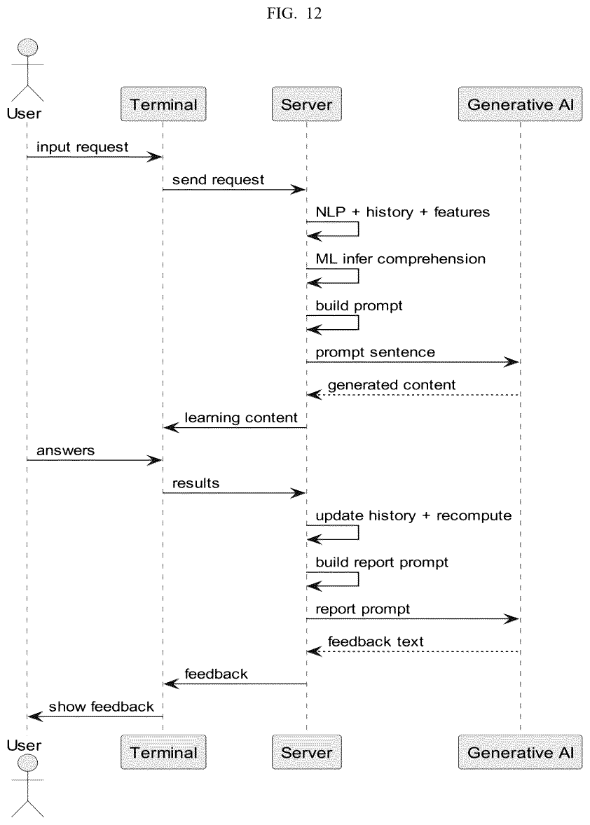

The following describes the processing flow using FIG. 12.

### Step 1:

User operates the terminal to initiate a learning session.
User opens an application or web page on the terminal and selects an input field for a learning request. User enters a natural language text such as “I want to learn differential and integral calculus from the basics.”
Input: raw text string typed by the user.
Output: a locally stored text value ready to be transmitted.
Terminal converts the text into an internal representation (for example, a string in a request object) and attaches metadata such as user identifier and timestamp.

### Step 2:

Terminal transmits the learning request to the server.
Terminal encapsulates the text and metadata in a structured message, for example, a request body with fields for user ID, request text, and device information. Terminal sends this message through a communication module using a network protocol such as HTTPS to a predefined server endpoint.
Input: user request text and metadata in local structures.
Output: network packet containing the structured request sent to the server.
Terminal performs data serialization into a transmittable format and writes the bytes to a network socket.

### Step 3:

Server receives and validates the learning request.
Server, via a communication interface, accepts the incoming network packet and deserializes it into internal data structures. Server verifies that mandatory fields (user ID, request text) are present and that the text length and format satisfy predefined constraints.
Input: serialized request data arriving over the network.
Output: validated request object containing user ID, request text, and timestamp, or an error response if validation fails.
Server parses the data, applies validation rules, and either constructs a valid request object for further processing or generates an error object to be returned.

### Step 4:

Server logs the request and stores raw input.
Server writes an entry into a logging system and inserts a record into a request table in a database, storing the raw text and identifiers.
Input: validated request object.
Output: persistent log entry and database record with a new request ID.
Server maps fields from the request object into database columns and executes a database insertion operation, thereby establishing a traceable record for subsequent processing.

### Step 5:

Server performs natural language preprocessing.
Server passes the request text to a natural language processing module. Server tokenizes the text into a token sequence, assigns part-of-speech tags, and constructs syntactic or dependency structures.
Input: raw text of the learning request.
Output: token sequence, part-of-speech tag sequence, and parse tree or dependency graph. Server executes NLP algorithms that compute linguistic features from the character stream, transforming unstructured text into structured linguistic representations.

### Step 6:

Server extracts topic, intention, and level indicators.
Server analyzes the linguistic structures to detect key phrases (for example, “differential and integral calculus”), verbs implying learning actions (for example, “learn”), and modifiers indicating scope (for example, “from the basics”).
Input: token sequence, part-of-speech tags, and syntactic relations.
Output: structured semantic summary containing a candidate learning target domain, subtopics, learning intention, and a qualitative level indication.
Server applies pattern matching, keyword dictionaries, and possibly a classification model to map linguistic features to domain concepts and intention categories.

### Step 7:

Server retrieves user learning history.
Server queries a learning history storage apparatus to obtain records associated with the user ID, including past lessons, quiz results, timestamps, and difficulty tags.
Input: user identifier and target domain information.
Output: a set of historical records grouped by topic or concept.
Server executes database queries with filtering on user and topic fields and aggregates the resulting records into in-memory structures for further computation.

### Step 8:

Server generates feature data from learning history.
Server computes statistical features from the historical records, such as average scores, number of attempts, completion ratios, recency-weighted performance, and cumulative time spent per concept.
Input: raw learning history records.
Output: numerical feature vectors representing the user's current learning state per topic or concept.
Server performs arithmetic operations (averages, sums, variances), applies time decay functions, and normalizes values into bounded ranges, thereby converting raw records into compact numeric representations.

### Step 9:

Server applies a machine learning model to compute a comprehension index.
Server feeds the feature vectors and the identified learning target domain into a trained neural network or other machine learning model. Server executes forward propagation through the model and obtains numerical comprehension indices for relevant concepts.
Input: feature vectors and target domain identifiers.
Output: comprehension index values for each concept, typically real numbers between zero and one.
Server performs matrix multiplications, non-linear activations, and normalization operations according to the model architecture, transforming input features into estimated understanding scores.

### Step 10:

Server determines learning strategy information.
Server compares comprehension indices against predefined thresholds and combines them with the learning intention to assign strategy labels and select content parameters.
Input: comprehension indices, learning intention, and target domain.
Output: learning strategy information including selected learning method, content types, difficulty bounds, and priority order of concepts.
Server executes decision rules and mapping functions that transform numeric scores and categorical intentions into a structured strategy configuration.

### Step 11:

Server constructs a prompt sentence for the generative AI model.

Server composes a text-based prompt sentence by embedding the analysis results, comprehension indices, and strategy parameters into a template.

Input: learning target domain, subtopics, comprehension indices, and learning strategy information.
Output: a prompt sentence formatted as a natural language instruction containing contextual data and explicit generation requirements.
Server concatenates strings, inserts numeric values as text, and arranges sections in a predetermined order to produce a coherent prompt that encodes the internal state.

### Step 12:

Server requests content generation from the generative AI model.
Server transmits the prompt sentence to a generative AI model and specifies inference parameters such as maximum output length and sampling settings.
Input: prompt sentence and generation parameters.
Output: generated text containing candidate explanations, example problems, and quiz questions.
Server sends the prompt through an interface to the model, which processes the tokenized input and returns a sequence of output tokens that the server decodes into text.

### Step 13:

Server parses and structures the generated content.
Server analyzes the returned text, detects section boundaries and labels (for example, “Explanation,” “Example Problems,” “Quiz”), and splits the content accordingly.
Input: raw generated text from the generative AI model.
Output: structured learning content objects categorized by type and annotated with associated concepts and estimated difficulty.
Server uses pattern recognition, delimiter detection, and heuristic rules to transform a continuous text stream into discrete content items stored in internal data structures.

### Step 14:

Server selects and packages content for presentation.
Server compares the structured content items with the learning strategy information and filters out items that do not satisfy difficulty or coverage conditions. Server orders the remaining items into a recommended sequence.
Input: structured learning content objects and learning strategy information.
Output: a content package specifying an ordered list of content items and associated metadata for delivery to the terminal.
Server performs selection and ranking operations based on scoring functions that combine strategy priorities, concept coverage, and variety constraints.

### Step 15:

Server transmits content information to the terminal.
Server serializes the content package into a transmittable format and sends it through the communication interface to the terminal.
Input: content package object with ordered content items.
Output: network response containing the serialized content package.
Server maps internal fields to a standardized response structure, encodes it, and writes it to the network channel.

### Step 16:

Terminal renders the received content for the user.
Terminal deserializes the content package and converts each item into graphical user interface elements, such as text blocks, interactive questions, or navigation controls.
Input: serialized content package received from the server.
Output: rendered display elements on the user's screen and interactive input widgets. Terminal parses the package structure, selects appropriate display templates per content type, and constructs a user interface layout that the user can view and interact with.

### Step 17:

User consumes the content and provides responses.
User reads explanations, works through example problems, and answers quiz questions by selecting options or entering text on the terminal.
Input: displayed content items.
Output: user actions and responses captured locally by the terminal.
Terminal records each interaction, including answer values, timestamps, and any use of hints or navigation events.

### Step 18:

Terminal sends learning result information to the server.
Terminal aggregates the recorded user actions into a result data set that associates each content item with user responses and performance metrics. Terminal transmits this data to the server through the communication module.
Input: locally stored interaction records.
Output: structured learning result information delivered to the server.
Terminal formats the data according to a predefined schema, serializes it, and sends it as a request to a result-processing endpoint.

### Step 19:

Server evaluates user performance.
Server receives the learning result information and matches user answers with correct answers stored in the structured content objects. Server computes scores, accuracy rates, and timing statistics.
Input: learning result information and reference answer data.
Output: performance metrics per content item and aggregated performance metrics per concept or session.
Server performs comparison operations, arithmetic calculations, and aggregation procedures to derive quantitative measures of user performance.

### Step 20:

Server updates learning history and recomputes features.
Server appends new performance data to the learning history records and recalculates aggregate statistics. Server updates feature vectors to incorporate the new results.
Input: performance metrics and existing learning history records.
Output: updated learning history information and new feature vectors representing the updated learning state.
Server executes database insert and update operations, recomputes statistics using arithmetic and time-decay functions, and replaces or augments the previous feature representations.

### Step 21:

Server recalculates the comprehension index.
Server feeds the updated feature vectors into the machine learning model, performs inference again, and obtains new comprehension indices that reflect the latest performance.
Input: updated feature vectors.
Output: new comprehension index values per concept.
Server repeats the model's forward pass, updating internal estimates of user understanding.

### Step 22:

Server generates learning report information.
Server constructs a report structure that includes the new comprehension indices, changes from prior indices, recent scores, and recommended next topics based on system rules.
Input: updated comprehension indices and recent performance metrics.
Output: structured learning report information summarizing the user's status and suggested next steps.
Server computes differences between old and new scores, classifies areas of improvement or difficulty, and encodes this analysis into a machine-readable report format.

### Step 23:

Server constructs a report-oriented prompt sentence.
Server converts the structured learning report information into a natural language-ready context and embeds it in a template to form a prompt sentence intended for feedback generation.
Input: learning report information and report template definition.
Output: report-oriented prompt sentence specifying details to be conveyed to the user.
Server inserts numerical values, topic names, and recommendations into designated positions within the template, forming a coherent narrative instruction for the generative AI model.

### Step 24:

Server requests feedback generation from the generative AI model.
Server sends the report-oriented prompt sentence to the generative AI model and requests generation of a concise explanatory text.
Input: report-oriented prompt sentence.
Output: generated feedback text describing the user's progress and future recommendations.
Server initiates another inference call to the model and decodes the returned tokens into a human-readable message.

### Step 25:

Server delivers feedback to the terminal.
Server prepares a response that includes the generated feedback text and any associated metadata, then transmits it to the terminal.
Input: generated feedback text.
Output: serialized feedback message sent over the network.
Server encapsulates the feedback in a response structure and writes it to the communication channel.

### Step 26:

Terminal displays the feedback to the user.
Terminal receives the feedback message, parses it, and presents the text in a dedicated view, such as a “Progress Report” or “Feedback” screen.
Input: serialized feedback message.
Output: on-screen textual feedback visible to the user.
Terminal renders the text with appropriate formatting and may provide controls for the user to start the next recommended learning activity based on the feedback.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented learning support systems typically rely on static rule-based logic or simple scoring functions to generate learning plans and feedback. In such systems, a processor merely aggregates test scores or completion rates and applies predetermined threshold rules to select content to be presented to a user. As a result, these systems are unable to fully exploit complex patterns in time-series learning history data, and they provide limited personalization. Moreover, the generated feedback is often presented as fixed templates or simple text fragments, which lack rich context and do not adapt to the evolving understanding level and emotional state of the user.

From the perspective of computer technology itself, there are several shortcomings. First, conventional systems do not integrate statistical or machine learning processing, time-series progress computation, and natural-language generation in a unified pipeline executed by a processor. The processor therefore fails to efficiently transform raw multi-dimensional learning logs into structured indicators that can be consumed both by downstream algorithms and by human users. Second, while generative models have recently become available, existing systems typically invoke such models in an ad hoc manner, using unstructured or manually crafted prompts, without programmatically embedding structured evaluation data. This leads to inefficient utilization of computational resources, unstable output quality, and difficulty in reproducing or controlling the generated feedback. Third, current systems do not provide a mechanism for automatically converting machine-level evaluation results into a control signal that can adjust subsequent learning plans and content delivery in a closed feedback loop.
Accordingly, there is a need for an improved computer-implemented technique in which a processor systematically: (i) acquires and preprocesses user-related learning data; (ii) computes numerical comprehension indicators using statistical or machine learning processing; (iii) generates time-series learning progress indicators and visualization information; (iv) constructs structured prompt sentences for a generative model; (v) integrates natural-language explanations returned from the generative model into machine-generated reports; and (vi) derives control prompt sentences that automatically tailor future learning plans and presentation of educational resources. By improving how the processor represents, transforms, and utilizes learning-related data and generative outputs, the overall operation of the computer system can be made more efficient, more adaptive, and more technically robust.

The specific processing by the specific processing unit 290 of the data processing device 12 in Example 2 is realized by the following means.

The present invention provides a server comprising a processor configured to acquire user-related information by receiving, through an interface, identification information of a user and information on a learning target and by acquiring corresponding learning history information and evaluation result information from a storage device; to evaluate a comprehension level of the user by performing statistical processing or machine learning processing on the acquired user-related information and the learning history information so as to calculate a numerical comprehension indicator; to generate, based on the evaluation result, a learning progress indicator including time-series information and to generate visualization information including graph information or report information representing the learning progress indicator; to generate a prompt sentence including structured data regarding the evaluation result and the learning progress indicator, to input the prompt sentence to a generative model, and to acquire from the generative model a natural-language explanatory text regarding a learning policy or a learning plan for the user; to add the explanatory text to the report information so as to generate learning report information and to transmit the learning report information in an electronic document format to a user terminal; and to generate a control prompt sentence, based on the learning report information, for individually adjusting a learning plan of the user and controlling presentation of educational information resources. This enables the server to improve computer operation by transforming raw learning logs into structured numerical indicators and time-series progress data, by programmatically embedding such structured data into prompt sentences for controlled interaction with a generative model, and by automatically converting both machine-learned evaluation results and generated natural-language feedback into control signals that dynamically adjust subsequent content delivery, thereby enhancing the efficiency, adaptability, and technical performance of the learning support system as a whole.

The term “user-related information” refers to information associated with an individual user, including at least identification information of the user, information on a learning target, and any data indicating the user's learning behavior, test results, or interaction history with a learning system.

The term “identification information of a user” refers to data that uniquely or quasi-uniquely identifies a user within a system, such as a user ID, account ID, or other machine-readable identifier managed by the system.
The term “information on a learning target” refers to information indicating a subject, topic, course, or other learning objective for which the user engages in learning activities and for which evaluation and feedback are generated.
The term “learning history information” refers to recorded data representing past learning activities of the user, including, for example, test scores, question-level responses, timestamps of study sessions, and completion status of learning units.
The term “evaluation result information” refers to data representing outcomes of prior evaluations of the user's learning, such as previously computed scores, comprehension indicators, or other assessment metrics stored in a storage device.
The term “storage device” refers to any hardware or combination of hardware capable of storing digital information, such as a magnetic storage device, semiconductor storage device, optical storage device, or a storage service provided over a network.
The term “comprehension level” refers to a degree to which the user is assessed to understand or master a given learning target, as expressed by a numerical or categorized indicator derived from analysis of learning data.
The term “statistical processing” refers to processing in which statistical methods are applied to data, including at least operations such as aggregation, averaging, variance computation, trend analysis, or regression-based estimation performed by a processor.
The term “machine learning processing” refers to processing in which a trained computational model is applied to input data in order to infer or predict one or more output values, the computational model being obtained through a training process using example data.
The term “numerical comprehension indicator” refers to a value expressed on a numeric scale that quantitatively represents the comprehension level of the user with respect to a learning target or learning unit.
The term “learning progress indicator” refers to information representing temporal changes in the user's learning status, including at least a time-series sequence of comprehension indicators or related metrics.
The term “time-series information” refers to data in which each element is associated with a point in time or a time interval, enabling analysis of changes over time.
The term “visualization information” refers to representation data intended for visual display, including at least graph information, chart information, or formatted report information that visually expresses evaluation results or learning progress.
The term “graph information” refers to structured data defining a graphical representation such as a line chart, bar chart, or similar plot, including at least coordinates, axes, labels, and associated parameters used for rendering.
The term “report information” refers to structured or semi-structured content that summarizes evaluation results, learning progress, and related explanations in a form suitable for presentation to a user or a stakeholder.
The term “prompt sentence” refers to a sequence of one or more natural-language expressions and optionally embedded structured data that is supplied as input to a generative model to request a corresponding output.
The term “structured data” refers to data organized according to a predefined schema, including, for example, key-value pairs, tabular data, or labeled fields that can be programmatically parsed and processed.
The term “generative model” refers to a computational model that, upon receiving an input such as a prompt sentence, generates output data including at least natural-language text produced according to learned statistical patterns.
The term “natural-language explanatory text” refers to text expressed in a human language that describes, explains, or interprets evaluation results, learning policies, or learning plans in a manner understandable by human readers.
The term “learning policy” refers to a strategy or guideline that indicates how the user should proceed with learning activities, including priority topics, pacing, and recommended learning approaches.
The term “learning plan” refers to a concrete plan or schedule specifying learning tasks, sequence of materials, or time allocation for the user over a specified period.
The term “learning report information” refers to information obtained by combining report information with natural-language explanatory text, the combined information being intended to present an integrated view of evaluation results and recommendations.
The term “electronic document format” refers to a digital file format suitable for storage, transmission, and display of document content, including at least formats that can contain text and images, such as a portable document format.
The term “user terminal” refers to an information processing apparatus operated by a user, such as a personal computer, mobile terminal, tablet device, or similar device capable of receiving and displaying electronic document data.
The term “educational information resources” refers to digital content used for learning, including at least instructional materials, practice problems, explanatory documents, and multimedia content related to a learning target.
The term “control prompt sentence” refers to a prompt sentence generated for use by a control process or by another computational model, the prompt sentence encoding instructions or conditions for adjusting a learning plan or content delivery.
The term “data preprocessing” refers to processing that transforms raw data into a form suitable for subsequent analysis, including at least selection, cleansing, normalization, format conversion, and feature extraction.
The term “comprehension evaluation value” refers to a numeric value or category assigned to represent the evaluated degree of understanding of a user with respect to a learning unit or learning target.
The term “achievement degree” refers to a measure of how much of a learning unit, learning objective, or performance target the user has completed or satisfied.
The term “learning unit” refers to a discrete element of learning content or activity, such as a lesson, topic, module, or problem set, defined as a unit for evaluation and planning.
The term “change in comprehension level over time” refers to a difference or trend in comprehension indicators measured across multiple time points for the same user and learning target.

The term “learning effectiveness indicator” refers to a metric that quantifies the impact of a particular type of educational material or activity on the user's comprehension level or performance.

The term “type of educational material” refers to a classification of educational information resources, including at least categories such as text-based materials, problem sets, interactive content, or audiovisual materials.

The term “response text” refers to natural-language text generated by the generative model in response to a prompt sentence, the text including explanations, recommendations, or other content requested by the prompt.
The term “interactive content” refers to content that enables bidirectional interaction between the user and the system, including at least dialog-based interfaces, adaptive quizzes, or dynamic learning activities.
The term “report content” refers to the substantive information contained in a report, including evaluation summaries, charts, tables, and explanatory passages presented to the user or other recipients.
The term “emotional state of the user” refers to an estimated affective condition of the user, such as motivation, frustration, or confidence, as inferred from learning behavior data or explicit user input.

In one embodiment, a server implements the invention by executing stored instructions on one or more processors. The server is connected via a network to one or more terminals operated by users. The server and the terminals each include at least a processor, a memory, a storage device, a display unit, and a communication interface. The server executes a learning support application that performs data acquisition, numerical evaluation, visualization, prompt generation, interaction with a generative AI model, and report generation. The terminal executes a client application, such as a web browser or a native mobile application, for user interaction.

The server runs on general-purpose computing hardware, such as a rack-mounted computer or a virtual machine instance in a data center, having a central processing unit with multiple cores, a semiconductor main memory, and a nonvolatile storage device such as a solid-state drive. The server may operate under an operating system such as a general-purpose server operating system. The server further executes an application framework for providing an application programming interface over a communication protocol such as HTTP over TLS. The server stores learning history information and evaluation result information in a relational database management system. As an example, the server uses a relational database engine and communicates with the engine using a database driver. The learning history information is stored in normalized tables, such as a user table, a learning session table, a test result table, and a question response table. Each record includes fields such as user identifier, subject identifier, topic identifier, timestamp, raw score, maximum score, and response correctness. The evaluation result information is stored in additional tables that include fields for comprehension indicators, learning progress indicators, and model metadata.
The server uses an analysis runtime based on a high-level programming language runtime environment. Within this environment, the server loads software libraries for data processing and machine learning. For example, the server uses a data analysis library that implements a table-like data structure, and a machine learning library that implements regression and classification algorithms, ensemble models, and neural network training utilities. The server also uses a plotting library for generating graphical visualizations, and a document generation library for assembling electronic document files that contain text and image data.
The server reads learning history information and evaluation result information from the storage device and constructs an in-memory table data structure. The server defines the schema of this structure with columns such as user identifier, subject code, topic code, timestamp, score, normalized score, time spent, and difficulty level. The server performs data preprocessing operations including missing value imputation, type conversion, normalization, and feature extraction. For example, the server computes a moving average of scores per topic, a count of attempts per topic within fixed time windows, an interval since the last learning session, and a rate of change of the score over time. These feature values are stored as additional columns in the table.
The server applies statistical processing and machine learning processing to the preprocessed data to compute numerical comprehension indicators. In one embodiment, the server uses a gradient boosting regression model or a random forest regression model implemented in the machine learning library. The server trains the model offline using historical labeled data that include, for each user and topic, one or more target values representing an independently assessed comprehension level. During training, the server splits the data into training and validation subsets, computes a loss function such as mean squared error or cross-entropy, and updates model parameters by iteratively fitting decision trees to the residuals. The server performs hyperparameter optimization, for example by grid search or random search, to determine the number of estimators, maximum tree depth, learning rate, and other parameters that minimize the validation loss.
In an alternative embodiment, the server employs a neural network model for comprehension evaluation. The neural network may be a multilayer perceptron with an input layer corresponding to extracted features, one or more fully connected hidden layers with nonlinear activation functions such as rectified linear units, and an output layer providing a real-valued comprehension score. The server trains the neural network using stochastic gradient descent or an adaptive optimizer on batches of training examples, computes a loss function such as mean squared error between predicted scores and target comprehension labels, and updates the network weights by backpropagation. The server may apply regularization techniques such as dropout and L2 weight decay to improve generalization.
The server uses the trained model during inference by feeding the feature vectors derived from the most recent learning history information into the model. The server obtains as output a raw predicted comprehension value for each topic and optionally for an overall subject. The server normalizes the predicted values to a predetermined numeric range, for example 0 to 100, and stores the resulting numerical comprehension indicators as evaluation result information in the storage device. Because the server uses a trained model that incorporates temporal and contextual feature values, the comprehension indicators differ from simple averages of scores and encode non-linear patterns in the data, improving precision compared to conventional rule-based systems.
The server generates learning progress indicators by organizing the comprehension indicators as time-series values. For each user and topic, the server constructs a time-ordered sequence of comprehension indicators and associated timestamps. The server computes derived metrics such as a trend slope over a sliding window, a volatility measure such as standard deviation of recent comprehension values, and an acceleration metric representing the change in the slope of the trend. The server stores these derived metrics and uses them to detect periods of improvement, stagnation, or decline. This structured representation of learning progress enables efficient numerical analysis and targeted feedback.
The server generates visualization information by passing the time-series data and derived metrics to the plotting library. The server constructs line charts that plot comprehension indicators over time, bar charts that compare current comprehension levels across topics, and heatmaps that show performance across topics and time periods. The server defines axis labels, titles, legends, and color scales within the plotting library and renders the images in a raster or vector format. By computing the derived indicators and directly binding them to graphical elements, the server reduces the need for repeated query and aggregation operations during visualization, thereby improving responsiveness and reducing processor load.
The server assembles report information using a document generation library. The server combines the generated graphs, tabular summaries of comprehension indicators, and fixed or semi-fixed explanatory text segments into a report layout. The server creates a multi-page document, inserts images into designated frames, and renders tables containing numeric values and statistical summaries. The server then outputs the document as an electronic document format file suitable for display and printing. The structured workflow, from data preprocessing to document assembly, improves data management and reduces inconsistencies between the displayed graphs and underlying numeric values.
The server constructs a prompt sentence for a generative AI model by embedding structured data into a natural-language template. The server formats feature information, such as comprehension indicators, achievement degrees for learning units, and changes in comprehension over time, into textual form. For example, the server may generate a prompt sentence of the form:
“Based on the following learning data: algebra comprehension score 82, geometry comprehension score 61, calculus comprehension score 45, with algebra improving by 10 points in the last month and calculus decreasing by 5 points, please describe the user's strengths and weaknesses and propose a detailed one-week learning plan.”
In another example, the server may generate a prompt sentence of the form:
“Using the latest mathematics learning history and test results for this user, analyze the change in understanding level compared to the previous month, summarize the trend in one concise paragraph, and list five concrete practice tasks that the user should complete before the next test.”
The server programmatically constructs these prompt sentences by inserting numeric values and topic names derived from the structured data into predetermined templates. The server then transmits the prompt sentence to a generative AI model that is deployed on a separate computation node or service. The generative AI model can be, for example, a transformer-based language model with multiple layers of self-attention, trained on large-scale text corpora using maximum likelihood estimation. The server invokes the model through an application programming interface exposed by a model-serving system.
The server receives, from the generative AI model, a response text in natural language. The response text includes narrative explanations of the user's learning status, topic-specific feedback, and stepwise recommendations for future learning. The server inserts the response text into the previously assembled report as an explanatory section and as a recommended action section. By storing structured data and then using that data to generate controlled prompt sentences, the server constrains the generative model output to be aligned with the computed indicators, which reduces variability and irrelevant content. This programmatic prompt construction and structured data embedding provide a technical improvement over ad hoc manual prompt design, contributing to more stable and reproducible results.
The server also generates a control prompt sentence that serves as a control signal for subsequent system operations. For example, the server may generate a control prompt sentence of the form:
“Adjust the learning sequence so that topics with comprehension score below 60 are prioritized, and allocate at least 40% of the next session to practice problems in geometry and calculus.”
The server interprets or converts this control prompt sentence into structured control parameters, such as topic priority lists and time allocation ratios. The server then writes these parameters into the storage device as configuration records associated with the user. When the user next accesses the learning application, the server uses these stored control parameters to select which educational information resources to present, in which order, and in what quantity. This closed-loop mechanism, in which computed evaluation results and generated explanatory text are converted into machine-readable control parameters, allows the server to automatically adjust content delivery in a manner that is not merely a direct automation of human selection.
The terminal provides a user interface for data input and report viewing. The terminal displays learning tasks, such as question sets or interactive exercises, and records user responses and timestamps. The terminal sends this user-related information to the server over a network. The terminal also receives the electronic document file containing the learning report information and renders it on a display. The user can scroll through pages, zoom into charts, and read the explanatory text. In some embodiments, the terminal allows the user to provide explicit feedback about the perceived difficulty or emotional state, and transmits such feedback as additional data fields to the server, enhancing the feature set used for comprehension evaluation.
The user interacts with the system by performing learning tasks on the terminal. The user answers questions, reads explanations, and follows recommended study plans. When the user completes a new test or a set of exercises, the terminal sends detailed result data to the server. The server integrates this new data into the learning history information, retriggers the analytical sequence, and produces updated comprehension indicators, learning progress indicators, and reports. As a result, the server maintains an up-to-date model of the user's comprehension over time.
From a technical standpoint, the described configuration improves computer technology in several ways. The server reduces redundant processing by reusing precomputed derived metrics in multiple downstream tasks, improving processing speed. The server's use of feature-rich models captures non-linear relationships in the learning history, leading to more accurate comprehension indicators than simple rule-based scores. The structured prompt generation approach, in which numeric and categorical data are embedded into prompt sentences under controlled templates, improves the efficiency of communication between the server and the generative AI model and stabilizes the quality of generated text. The integration of the generative AI model with deterministic control parameter derivation enables the system to automate content selection and scheduling according to complex evaluation results, rather than simply mirroring human decisions.
In addition, the server can employ data compression and caching strategies to reduce communication load. For example, the server may cache intermediate feature tables keyed by user and subject identifiers, so that incremental updates only require processing of newly added records. The server may also compress report documents during transmission to terminals, reducing network bandwidth consumption. These measures contribute to overall system performance.
In a further embodiment, the server can adopt alternative machine learning algorithms such as recurrent neural networks or temporal convolutional networks to directly model time-series learning data. The server may encode per-session features into sequences and apply attention-based architectures that capture long-term dependencies in learning behavior. The server can also adjust model parameters adaptively for different user segments by using meta-learning techniques or hierarchical models. These alternative configurations further extend the technical capability of the system to handle heterogeneous learning trajectories.
In another embodiment, the server may integrate anomaly detection algorithms to identify irregular patterns, such as sudden unexplained drops or spikes in comprehension indicators that could reflect data errors or atypical behavior. The server can mark these anomalies in the visualization information and can selectively exclude anomalous segments from training data to improve model robustness.
By implementing these embodiments, the server, the terminal, and the user cooperate through concrete hardware and software components to carry out the invention. The server executes specific data structures, algorithms, and model architectures that are tailored to the learning evaluation and feedback task. The system thereby provides not only functional learning support but also measurable improvements in computational efficiency, accuracy of evaluation, and quality-controlled integration of generative AI outputs into a dynamically controlled learning environment.

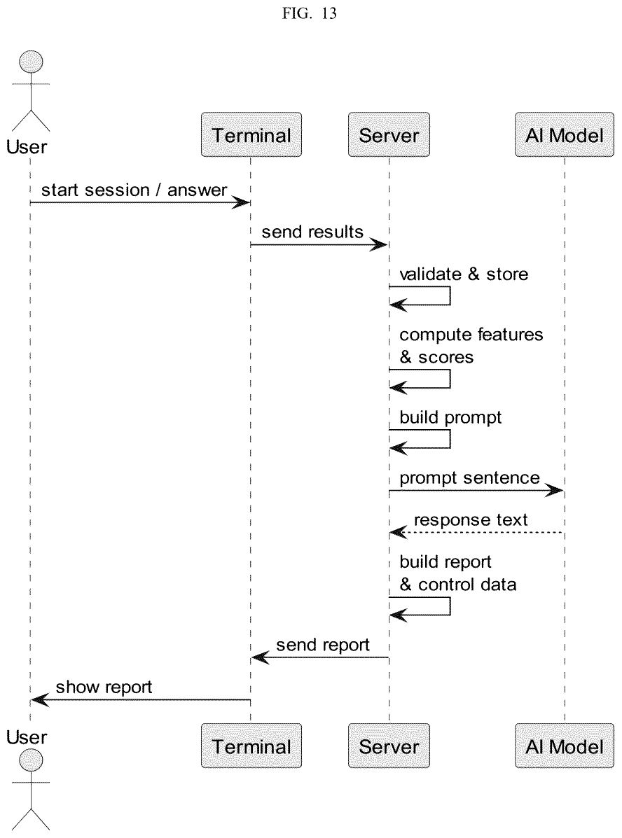

The following describes the processing flow using FIG. 13.

### Step 1:

The user operates the terminal to start a learning session and select a learning target.
The terminal displays a list of subjects and topics, and the user selects, for example, mathematics and a specific topic such as algebra.
Input: current user identifier and available subject/topic list stored on the terminal or received from the server.
The terminal records the selected subject and topic together with the user identifier and a timestamp.
Output: a selection record including user identifier, subject, topic, and timestamp, which the terminal prepares to send to the server.

### Step 2:

The terminal presents learning content and test questions to the user and collects response data.
Input: content metadata and question sets received from the server or cached locally, including question identifiers, correct answers, difficulty levels, and time limits.
The terminal renders questions on the display, captures the user's answers, start and end times, and any optional feedback such as perceived difficulty.
The terminal computes a raw score per question by comparing the user's answer with the stored correct answer and aggregates scores at the test level.
Output: a detailed result dataset containing user identifier, subject, topic, test identifier, question identifiers, user answers, correctness flags, per-question scores, total score, timestamps, and optional self-reported information.

### Step 3:

The terminal transmits the detailed result dataset to the server.
Input: the result dataset from Step 2.
The terminal serializes the dataset into a structured message and sends it to the server via a secure network protocol.
The terminal waits for confirmation from the server that the data has been received and stored.
Output: a network request containing the result dataset and an acknowledgment from the server.

### Step 4:

The server receives and validates the result dataset.
Input: the structured message sent from the terminal in Step 3.
The server parses the message, verifies the user identifier, checks that the subject and topic are valid, and confirms that each score is within an allowed range (for example, 0 to 100).
The server rejects or flags inconsistent records, such as missing required fields or impossible timestamps, and logs validation errors.
Output: a cleaned result dataset ready for storage and a validation log indicating accepted and rejected entries.

### Step 5:

The server stores the cleaned result dataset in a storage device.
Input: the cleaned result dataset from Step 4.
The server maps fields in the dataset to columns in relational tables for users, learning sessions, test results, and question responses.
The server executes insertion operations to write new rows into the appropriate tables, linking them with foreign keys based on user, subject, and topic identifiers.
Output: updated database tables containing the new learning history information and a confirmation that the write operations have completed.

### Step 6:

The server retrieves comprehensive learning history information for the user.
Input: user identifier and learning target (subject and topic) obtained from the selection record and stored session context.
The server issues query operations to the database, joining tables for past test results, question responses, and learning sessions.
The server filters records by user and subject, and optionally by time range (for example, the last six months).
Output: a raw history dataset containing all relevant records for the user and learning target, including scores, timestamps, and contextual attributes.

### Step 7:

The server constructs and preprocesses a tabular data structure from the raw history dataset.
Input: the raw history dataset from Step 6.
The server loads the dataset into an in-memory table with defined columns such as user identifier, subject, topic, test identifier, timestamp, score, maximum score, time spent, difficulty level, and correctness ratio.

The server performs data operations including type conversion, sorting by timestamp, imputing missing values (for example, replacing missing scores with topic-level means), and discarding invalid entries.

Output: a cleaned and chronologically ordered table suitable for feature computation.

### Step 8:

The server computes feature values for comprehension evaluation.
Input: the cleaned table from Step 7.
The server groups rows by topic and time window (for example, weekly or monthly) and computes aggregate metrics such as average score per topic, total number of attempts, success rate, and average time per question.
The server derives time-series features, including moving averages, differences between consecutive scores, slopes over predefined windows, and intervals since the last learning session.
The server adds these feature columns to a separate feature table that aligns each feature vector with a user, subject, topic, and reference time.
Output: a feature table containing numerical feature vectors for each user-topic-time combination.

### Step 9:

The server evaluates the user's comprehension level using a trained prediction model.
Input: the feature table from Step 8 and model parameters loaded from persistent storage.
The server selects feature columns in a predetermined order and converts them into numeric arrays.
The server feeds each feature vector into a trained regression or classification model, such as a gradient boosting model or a multilayer perceptron, to compute a raw comprehension score.
The server normalizes the raw scores to a fixed range (for example, 0 to 100) and rounds them to predefined precision.
Output: a set of numerical comprehension indicators per topic and, optionally, an overall comprehension indicator for the subject.

### Step 10:

The server generates learning progress indicators as time-series data.
Input: the newly computed comprehension indicators from Step 9 and previously stored comprehension indicators for the user.
The server appends the new indicators to existing series sorted by timestamp, forming continuous sequences per topic.
The server computes time-series descriptors such as trend slopes, rolling averages, volatility measures, and indicators of improvement or decline (for example, flags when scores rise or fall beyond thresholds).
Output: learning progress indicators that contain both raw time-series scores and derived metrics for each user and topic.

### Step 11:

The server creates visualization data structures for graphs.
Input: the learning progress indicators from Step 10.
The server maps time-series values to axes, defines series for each topic, and assigns color and line styles.
The server prepares graph configuration objects specifying titles, axis labels, tick intervals, and legend contents based on the subject and topics.
Output: graph configuration data and associated time-series values ready for rendering.

### Step 12:

The server renders graphical visualizations of comprehension and progress.
Input: graph configuration data and time-series values from Step 11.
The server invokes a plotting library to draw line charts of comprehension scores over time, bar charts comparing topics, and other visualizations such as heatmaps.
The server writes the output as image files in a selected format, for example, raster images suitable for embedding in electronic documents.
Output: one or more image files representing visualizations of the user's comprehension and progress.

### Step 13:

The server assembles report information from numeric data and visualizations.
Input: the comprehension indicators, learning progress indicators, and image files from Steps 9, 10, and 12.
The server uses a document layout template that defines positions for graphs, tables, and text blocks.
The server generates tables summarizing current and historical comprehension indicators and inserts them into the document structure along with the graph images.
Output: a structured report representation describing the user's current status and learning history, without yet including generative text.

### Step 14:

The server constructs a prompt sentence for a generative AI model using the structured evaluation data.
Input: comprehension indicators, learning progress indicators, and any relevant context such as subject and target period.
The server selects key numeric values (for example, per-topic scores, recent changes, and notable trends) and converts them into textual phrases inserted into one or more predetermined template sentences.
For example, the server may generate the following prompt sentence:
“Based on the following understanding scores and recent test results for the user: algebra 82, geometry 61, calculus 45, and the time-series scores over the past three months, please generate a report that explains the user's strengths and weaknesses, and propose a detailed one-week study plan to improve geometry and calculus.”
Output: a complete prompt sentence in natural language that embeds structured evaluation data.

### Step 15:

The server sends the prompt sentence to a generative AI model and receives a response text.
Input: the prompt sentence from Step 14.
The server transmits the prompt sentence to a model-serving endpoint that exposes a generative language model and specifies parameters such as maximum response length and sampling temperature.
The server waits for the model-serving system to process the prompt and return a natural-language response that includes explanations and recommendations.
Output: a response text containing narrative descriptions of the user's learning status and recommended learning actions.

### Step 16:

The server integrates the response text into the structured report.
Input: the structured report representation from Step 13 and the response text from Step 15.
The server inserts the response text into designated sections of the report, such as an “AI-generated analysis” section and a “Personalized study plan” section.
The server ensures that references in the response text are consistent with the numeric data, for example by checking topic names and ranges of scores.
Output: a completed learning report information object that combines visualizations, numeric summaries, and generative explanations.

### Step 17:

The server generates and stores an electronic document file for the learning report.
Input: the completed learning report information object from Step 16.
The server invokes a document generation library to render the report into an electronic document format, positioning text and images according to the layout template.
The server writes the resulting file to the storage device and creates a reference entry linking the file path or identifier to the user and the report creation time.
Output: a stored electronic document file representing the learning report and a reference for later retrieval.

### Step 18:

The server generates a control prompt sentence for adapting future learning content.
Input: the comprehension indicators, learning progress indicators, and optionally parameters derived from the generative response text.
The server identifies topics whose comprehension scores fall below predefined thresholds, calculates their relative priority, and determines recommended time allocation for each topic.
The server formats these control decisions into a textual control prompt sentence such as:
“Prioritize all topics with comprehension score below 60, schedule at least twice as many practice items in these topics as in others, and ensure that geometry and calculus occupy at least 40 percent of the next learning session.”
Output: a control prompt sentence that encodes content selection and scheduling policies for subsequent sessions.

### Step 19:

The server converts the control prompt sentence into machine-readable control parameters.
Input: the control prompt sentence from Step 18.
The server parses the sentence by matching topic names and numeric thresholds and extracts structured parameters such as topic priority ranking, relative content proportions, and minimum session allocations.
The server stores these parameters in control configuration tables linked to the user, subject, and validity period.
Output: updated control configuration data that the server will use to guide future content delivery.

### Step 20:

The server transmits the learning report to the terminal.
Input: the stored electronic document file from Step 17 and user terminal identification.
The server either sends the file as an attachment through a messaging channel or provides a secure download link and notifies the terminal of its availability.
The server logs the transmission result and updates a status record indicating that the report has been delivered.
Output: a transmitted electronic document containing the learning report ready to be displayed on the terminal.

### Step 21:

The terminal receives and displays the learning report to the user.
Input: the electronic document file or link sent by the server in Step 20.
The terminal downloads the file if necessary, opens it in a viewer component, and renders text and images on the display.
The terminal allows the user to navigate through pages, zoom into charts, and read the generated explanations and recommendations.
Output: a visual presentation of the learning report on the terminal and, optionally, user interactions such as scrolling and annotations.

### Step 22:

The user reviews the report and initiates the next learning session based on the recommendations.
Input: the displayed learning report and the user's own learning objectives.
The user reads the explanations and study plan, then returns to the main learning interface on the terminal and selects new exercises or tests that align with the recommendations.
The user's new selections and subsequent actions generate additional learning data that will be processed by the server in the same sequence of steps.
Output: new learning activities guided by the report, leading to new input data for the next evaluation cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented learning support and work-support systems typically rely on static rules, fixed recommendation logic, or manually designed workflows that treat learning content selection, emotional-state handling, dialog generation, and reporting as separate and loosely coupled functions. In such systems, a central processor usually selects learning materials or work instructions by simple filtering of a database based on coarse user attributes (such as grade or job role), and may optionally log performance. However, these systems rarely integrate fine-grained behavioral history, machine-learned understanding evaluation, and real-time emotion estimation in a unified control loop. As a result, the systems are unable to adapt the behavior of the underlying information-processing components in a timely and consistent manner.

Furthermore, in many existing architectures, a natural-language generation model, if present at all, is invoked in an ad-hoc fashion. Prompt sentences sent to such a model are often handcrafted, static, and disconnected from the internal data structures of the system. The processor is not architected to systematically construct, update, and re-use prompt sentences as a first-class control mechanism. This leads to inefficiencies in computation, increased developer burden in maintaining prompt templates, and inconsistent quality of generated learning plans, dialog responses, and reports. In other words, the computer itself is not configured to exploit generative models as programmable components in its control architecture.
Moreover, known systems generally do not treat emotional state as a structured, machine-interpretable signal that directly influences the behavior of the recommendation engine or dialog engine. Emotion detection, when present, is often implemented as a separate analytics feature and is not fused into the same processing pipeline that evaluates understanding, selects content, and produces reports. Consequently, the system fails to adjust difficulty, pacing, explanation style, or work assignment based on both cognitive and affective indicators, thereby reducing the effectiveness and robustness of the computer-implemented support.
Additionally, reporting mechanisms in existing systems are typically implemented as static dashboards or pre-defined templates that are updated by simple aggregation logic. The computer is not configured to feed structured progress and emotion trajectories into a generative model through a well-defined prompt interface to obtain adaptive summaries and recommendations. This limits the system's ability to deliver context-sensitive, role-specific reports to learners, workers, parents, instructors, or managers without manual customization. From the standpoint of computer technology, there is therefore a need for an improved system architecture in which a processor: (i) continuously acquires multi-modal user information including learning content, learning history, behavior history, and emotional state; (ii) transforms such information into feature data and performs machine-learning-based evaluation; (iii) programmatically constructs and regenerates prompt sentences as control signals to a generative model; and (iv) uses responses from the generative model to drive dynamic adaptation of learning plans, work plans, dialog content, and reporting. By defining prompt management and generative-model interaction as core computational operations of the processor, and by integrating understanding evaluation and emotion evaluation into a single feedback loop, the underlying computer system can be improved in terms of adaptability, modularity, and processing efficiency. The technical problem to be solved is to provide such an improved computer-implemented system that uses prompt-based interaction with a generative model, coupled with structured evaluation of understanding and emotional state, to dynamically control content selection, dialog behavior, and report generation in a unified and automated manner.

The specific processing by the specific processing unit 290 of the data processing device 12 in Application Example 2 is realized by the following means.

The present invention provides a server comprising a processor configured to acquire, via an information input/output device, input information including at least learning-related content data, historical interaction data, evaluation data, behavior data, and emotional-state data of a user; to generate feature data from the input information by executing character-information processing and statistical-information processing, and to evaluate, by executing machine-learning processing using the feature data, at least an understanding index and an emotional-state index of the user in a numerical or categorical form; to construct, based on an evaluation result of the understanding index and the emotional-state index and based on constraint conditions relating to a learning or work session, a prompt sentence including an instruction sentence to be input to a generative information-processing model, the prompt sentence further including at least user-profile information and session-context information; to input the prompt sentence to the generative information-processing model and obtain, from the generative information-processing model, response information including at least one of a learning plan, a work plan, dialog content, and report content; to generate, based on the response information, a personalized plan specifying at least items, difficulty levels, execution order, and required times, and to select and associate, from a storage device, content information corresponding to the personalized plan; to present the personalized plan and the content information via a user interface, to acquire additional information from the user including answer information, operation information, and additional emotional-state information, to update the evaluation result based on the additional information, and to regenerate, when a change in understanding or emotional state is detected, an updated prompt sentence to re-invoke the generative information-processing model so as to dynamically adjust the personalized plan; and to generate report information including at least learning-progress information, understanding-transition information, emotional-state-transition information, and recommended measures based on the evaluation result and an execution result of the personalized plan, and to output the report information in a form suitable for notification to the user and a related party. This enables the computer system to treat prompt sentences as explicit control data for a generative model, to tightly integrate machine-learning-based evaluation of understanding and emotional state into a feedback loop with the generative model, and thereby to improve the adaptability, coherence, and processing efficiency of computer-implemented learning support and work-support operations.

The term “processor” refers to a hardware or virtual computation unit, such as a central processing unit or an execution core, configured to execute program instructions to perform data acquisition, analysis, generation, and control operations described in the present specification.

The term “information input/output device” refers to a hardware or software interface component, such as a communication interface, display device, input device, or sensor interface, that enables the processor to receive information from a user and to present information to the user.
The term “input information” refers to any data acquired from a user or a user-related environment, including but not limited to learning-content data, learning-history data, evaluation-result data, behavior-history data, and emotional-state data.
The term “learning content” refers to data representing educational items or training items, such as topics, concepts, exercises, examples, or explanations, that are intended to be presented to a user for the purpose of learning or skill acquisition.
The term “learning history” refers to data representing past interactions of a user with learning content, including at least accessed items, completion status, response correctness, timestamps, and interaction patterns.
The term “evaluation result” refers to data representing outcomes of assessments, tests, quizzes, or other performance measurements, including scores, grades, pass/fail indicators, or other performance metrics.
The term “behavior history” refers to data representing user actions and usage patterns in a system, including operations such as item selection, navigation, time spent on tasks, retries, skips, and other interaction events.
The term “emotional state” refers to a cognitive or affective condition of a user, such as stress, joy, boredom, anxiety, or fatigue, inferred from sensor data, behavioral signals, or user input.
The term “character information processing” refers to text-oriented processing operations, including natural language processing operations such as tokenization, parsing, feature extraction, sentiment analysis, and semantic analysis applied to text data.
The term “statistical information processing” refers to processing operations that calculate statistical values, such as averages, variances, frequencies, distributions, correlations, or aggregated indicators, from numerical or categorical data.
The term “feature data” refers to structured numerical or categorical values derived from raw input information, which are used as inputs to machine-learning models to evaluate user understanding, skill level, and emotional state.
The term “understanding index” refers to a numerical or categorical indicator that represents an estimated degree of user understanding or mastery for a particular learning item or concept.
The term “weak-field index” refers to a numerical or categorical indicator that represents a topic, concept, or skill area in which the user's understanding index is below a predetermined threshold.
The term “work-skill-level index” refers to a numerical or categorical indicator that represents an estimated skill level or proficiency of a user with respect to a particular work task or job function.
The term “emotional-state index” refers to a numerical or categorical indicator that represents an estimated emotional condition of a user, derived from one or more measurements related to emotional state.
The term “machine learning processing” refers to computational procedures that apply a trained predictive model, such as a classification model or regression model, to feature data in order to estimate or infer target variables including understanding index or emotional-state index.
The term “generative information-processing model” refers to an information-processing model, such as a generative artificial intelligence model or a large language model, that produces text or structured data outputs in response to input data or prompt sentences.
The term “prompt sentence” refers to a text sequence, including instructions and contextual information, that is provided as input to a generative information-processing model in order to control the content, style, or structure of an output generated by the model.
The term “user profile” refers to data describing characteristics of a user, such as age, grade, role, skill level, preferences, or other attributes relevant to learning or work support.
The term “session context” refers to data describing conditions and parameters for a particular learning session or work session, such as target topics, time constraints, device type, and environmental conditions.
The term “response information” refers to any information output from a generative information-processing model in response to a prompt sentence, including but not limited to learning plans, work instructions, dialog content, and report content.
The term “personalized plan” refers to a learning plan or work plan whose items, difficulty levels, execution orders, and required times are customized for a specific user based on evaluation results and response information from a generative model.
The term “learning plan” refers to a structured sequence of learning activities, learning items, or tasks, specifying at least the content to be studied, the order of presentation, difficulty levels, and time allocations.
The term “work plan” refers to a structured sequence of work activities or tasks, specifying at least the tasks to be performed, their order, difficulty or complexity, and time allocations.
The term “content information” refers to data identifying or describing resources to be presented to a user, including learning-material information or work-procedure information.
The term “learning-material information” refers to data identifying or describing learning resources, such as documents, problem sets, multimedia items, or interactive exercises, that are used to implement a learning plan.
The term “work-procedure information” refers to data identifying or describing steps, guidelines, or instructions for performing a work task or job operation.
The term “storage device” refers to any memory or storage component, such as a database, file system, or non-volatile memory, configured to store input information, feature data, content information, plans, and report information.
The term “user interface” refers to a hardware and software arrangement, such as a graphical user interface or voice interface, that allows a user to receive information from the system and to input information to the system.
The term “additional information” refers to information acquired from a user during execution of a personalized plan, including answer information, operation information, and additional emotional-state information.
The term “answer information” refers to data representing user responses to questions, problems, or tasks, including selected answers, entered text, correctness indicators, and timestamps.
The term “operation information” refers to data representing user operations within an application, including button presses, navigation events, scrolling, pausing, replaying, or other interface actions.
The term “additional emotional-state information” refers to emotional-state-related data obtained during a session, including new sensor readings, updated sentiment analysis results, or explicit user feedback regarding emotional condition.
The term “dynamic adjustment” refers to modification, during an ongoing session, of elements of a personalized plan, such as items, difficulty levels, execution order, or pacing, based on updated evaluation results and additional information.
The term “learning-progress information” refers to data representing progress of a user with respect to learning objectives, including completed items, time spent, and changes in understanding index.
The term “understanding-transition information” refers to data representing changes in understanding indices over time, such as trends, improvements, or declines for specific learning items.
The term “emotional-state-transition information” refers to data representing changes in emotional-state indices over time, such as transitions between stress and relaxation during learning or work.
The term “recommended measures” refers to suggested actions or strategies for future learning or work, generated based on evaluation results and transitions, such as changing difficulty, altering study schedules, or adjusting work assignments.
The term “report information” refers to data structures that summarize evaluation results, progress information, transition information, and recommended measures, to be presented to a user or a related party.
The term “related party” refers to a person other than the primary user, such as an instructor, parent, supervisor, or manager, who is authorized to receive report information about the user's learning or work status.

In one embodiment, a server, a plurality of terminals, and one or more users cooperate to implement the claimed system. The server includes at least one hardware processor, a main memory, a non-volatile storage device, and one or more network interfaces connected to a data network. The terminals include at least one computation unit, a display device, an input device, and, in some embodiments, one or more sensors such as a camera and a microphone.

The server and the terminals execute software modules that implement the functions described below.
The server uses an operating system, a database management component, and an application framework to manage data and execute analyses. In a concrete implementation, the server uses a relational database management system to store structured records representing learning history, evaluation results, behavior history, emotional-state indices, content metadata, and report information. The server uses a high-level programming language environment to execute data processing and machine learning routines, including a numerical computation library, a data-frame library, and a machine-learning library. The server further uses a deep-learning framework to execute a neural network model that functions as a generative AI model and as an emotion-recognition model.
The server defines data structures in the database for each category of information. For example, the server defines a learning-history table including fields for user identifier, content identifier, timestamp, question identifier, correctness indicator, response time, and difficulty level. The server defines an evaluation table including fields for user identifier, topic identifier, understanding index, weak-field flag, and update timestamp. The server defines an emotion-log table including fields for user identifier, timestamp, emotional-state index, and confidence score. The server defines a content-metadata table including fields for content identifier, topic identifier, difficulty level, estimated time, and content type. By enforcing these schemas, the server can perform efficient indexed queries and joins, which reduces data-access latency and improves overall processing speed.
The server uses software libraries, such as a data-frame library and a numerical library, to transform raw input information into feature data with a standardized structure. The server computes, for each user and topic, statistical aggregates including correct-answer rate, average response time, number of attempts, and time since last practice. The server normalizes these values using, for example, min-max normalization or z-score normalization, and stores them as feature vectors in memory. The server thereby reduces the dimensionality and variance of the raw data, which improves the stability and convergence of downstream machine-learning models.
The server implements a machine-learning model, for example a gradient-boosted decision tree model or a multilayer perceptron, trained to output an understanding index for each topic. The server defines an input layer whose dimensions correspond to the feature vector components, one or more hidden layers with non-linear activation functions, and an output layer that produces either a continuous score or class probabilities for discrete understanding categories. The server uses a loss function such as mean squared error for regression or cross-entropy for classification, and the server updates model weights by a gradient-based optimization method. During training, the server applies techniques such as mini-batch training and early stopping to prevent overfitting. By doing so, the server configures an evaluation component that can transform multi-dimensional behavior and performance data into compact understanding indices with higher accuracy than simple rule-based thresholds. The server also implements an emotion-recognition model that uses sensor data from the terminals. In one configuration, the server uses a convolutional neural network to process images of the user's face and extract features such as eye openness, mouth curvature, and eyebrow position, followed by fully connected layers that output an emotional-state index.
The server may also use a recurrent or transformer-based network to process text data or speech-to-text transcripts to detect sentiment and emotional cues. The server defines a multi-task learning objective that simultaneously predicts, for example, stress level and engagement level, thereby utilizing shared representations to improve prediction accuracy.
The server trains this model using labeled data with known emotion annotations, optimizing a composite loss function that combines classification loss terms for each emotion dimension. This implementation allows the server to output a continuous or discrete emotional-state index that can be incorporated into the same feature space as understanding indices.
The server maintains a generative AI model that is configured as a parameterized sequence-to-sequence neural network, such as a transformer-based language model with multiple attention layers, feed-forward layers, and positional encodings. The server stores model parameters, including weight matrices for multi-head attention and feed-forward sub-layers, in non-volatile storage and loads them into memory during operation. The server fine-tunes this model on domain-specific corpora containing examples of learning plans, work instructions, dialog responses, and analytical reports, using a language-modeling objective and, in some cases, reinforcement-style preference optimization. By doing so, the server configures a generative AI model whose internal probability distributions are adapted to the educational and work-support context of the system.
The server uses a specialized prompt-construction module to assemble prompt sentences that control the behavior of the generative AI model. Unlike static templates, the server defines a data structure for prompt components, including sections for user profile, session context, evaluation summary, emotion summary, and desired output format. The server uses program logic to insert current values into these sections and to adjust wording based on predefined rules tied to quantitative thresholds of understanding and emotional-state indices. For example, the server uses a first phrasing when the understanding index is below a low threshold and a different phrasing when it is above a high threshold. This automatic, rule-driven variation of prompt content is not simply manual content creation; it is a systematic computation that maps numeric indices into prompt tokens and thereby changes model behavior in a repeatable, machine-controlled manner.
In one example, the server generates the following prompt sentence for a learning plan:
“Analyze this high-school student's performance: derivatives score=45/100 (weak), integrals score=78/100 (intermediate), limits score=90/100 (strong). The student appears mildly stressed based on emotion analysis. Create a 40-minute study plan focusing on derivatives basics, with small, low-stress steps. Output a list of steps, each with topic, difficulty, estimated time, and a short motivational phrase.”
In another example, the server generates the following prompt sentence for conversational tutoring:
“The learner is a high-school student currently in a derivatives basics lesson. The learner has repeatedly made mistakes differentiating x² and sin (x). The learner just wrote: ‘I still don't get how to use the chain rule.’ Explain the chain rule step by step with a very simple example, avoid formal proofs, and end with one practice question similar to the learner's current level.”
In a further example, the server generates the following prompt sentence for work instructions:
“The worker has elevated heart rate and facial analysis indicates fatigue. The worker is certified for both simple assembly tasks and complex inspection tasks. For the next 60 minutes, recommend specific tasks that reduce cognitive load but keep productivity acceptable. Provide a short instruction sentence to show to the worker.”
The server uses an application programming interface to send each prompt sentence and optionally supplementary structured data to the generative AI model and receives textual response information. The server parses the response information according to expected patterns, such as numbered lists or directives, and converts them into internal data structures representing learning plans, work plans, dialog responses, or report sections. By treating prompt sentences and responses as structured control signals rather than free-form text, the server can manage and evolve the behavior of the generative AI model as a component of a larger algorithmic pipeline.
The server uses the generated learning plan or work plan to select appropriate content from the storage device. The server executes database queries constrained by topic, difficulty level, and estimated time, and applies ranking logic that uses prior effectiveness metrics, such as user completion rates and average improvement in understanding index after exposure to a content item. The server thereby constructs a content list associated with each step of the personalized plan. Because the server uses both generative output and historical performance metrics, the server can improve accuracy of content selection and reduce unnecessary data transmission, which in turn reduces communication load between the server and the terminals.
The server records all intermediate evaluation results and decisions, including which prompt sentence was used, which response was received, and which items were selected. This traceability allows the server to perform meta-analysis of prompt effectiveness and to update prompt-generation rules over time. For example, the server can detect that certain prompt formulations produce more accurate or more efficient plans, as measured by subsequent improvements in understanding index or reductions in session length. The server then adjusts prompt-construction parameters accordingly, which constitutes an improvement to the underlying computer-implemented control strategy rather than a mere automation of human judgment.
The terminals provide the user interface and capture additional data. A terminal displays the personalized learning plan or work plan as a series of tasks or steps, indicating topics, difficulty levels, estimated times, and progress indicators. The terminal informs the server when the user starts a step, completes a step, or requests assistance. When the terminal includes a camera and microphone, the terminal continuously or periodically captures image frames and audio and sends them to the server for emotion analysis. The terminal may execute local pre-processing, such as downscaling images or compressing audio, to reduce communication bandwidth usage. By coordinating such pre-processing with the server's analytical pipeline, the system reduces network load and enables near-real-time feedback.
The user interacts with the system by selecting content, answering questions, performing tasks, asking questions in natural language, and providing explicit feedback on difficulty or satisfaction. The user can input text or speech, which the terminal converts into digital data and forwards to the server. The user's actions directly influence the behavior of the system because the server updates the understanding index and emotional-state index based on each new data point.
In some embodiments, the server uses a multi-module architecture that includes a data acquisition module, a feature-extraction module, an evaluation module, a prompt-management module, a generative-interaction module, a plan-generation module, a content-selection module, and a reporting module. The server connects these modules through defined data structures and interfaces. For instance, the feature-extraction module receives raw logs and emits fixed-length numeric vectors; the evaluation module receives those vectors and emits indexed evaluation results; the prompt-management module receives evaluation results and emits prompt sentences; the generative-interaction module receives prompt sentences and emits textual responses; the plan-generation module receives textual responses and emits structured plans; and the content-selection module receives plans and emits content lists. By formalizing this modular dataflow, the server can parallelize some computations, cache intermediate results, and apply incremental updates, which reduces total processing time and improves scalability.
From a technical standpoint, this configuration yields several effects. Because the server uses machine-learning-based evaluation rather than simple threshold checks, the server can capture non-linear relationships between behavioral features and understanding, thereby reducing misclassification of user ability and improving the precision of plan adjustments. Because the server uses real-time emotional-state indices as numeric inputs to the evaluation and prompt-generation processes, the server can dynamically alter explanation styles and task difficulty without human intervention, which reduces user frustration and enhances learning efficiency. Because the server treats prompt sentences as structured, programmable artifacts, the server can systematically optimize them, thereby improving the consistency and computational efficiency of interactions with the generative AI model.
In one alternative embodiment, the server deploys the generative AI model locally rather than as a remote service. The server stores the model weights in a high-performance storage device and uses hardware accelerators, such as graphics processing units or tensor-processing units, to execute inference. The server uses quantization and model-parallelism techniques to reduce latency and memory usage. In this configuration, the system reduces dependence on external network conditions and further shortens response times to user actions, resulting in an improved interactive experience.
In another embodiment, the server applies a different neural-network architecture to the emotion-recognition task, for example a hybrid model combining convolutional layers and recurrent layers, and ensembles multiple model outputs to increase robustness against noise.
In still another embodiment, the server uses an alternative optimization method, such as an adaptive gradient method, to update model weights during training, and employs data augmentation techniques such as random cropping, flipping, or noise injection on facial images to improve generalization. These variations all fall within the scope of configuring the server to compute emotional-state indices and to use such indices within the same computational loop that generates and updates personalized plans.
In yet another embodiment, the server uses an internal rule engine alongside the generative AI model. The server encodes non-conventional rules that operate directly on numeric indices, such as “if the emotional-state index indicates high stress and the understanding index is low for the current topic, then force the generative AI model to produce a shorter and simpler plan by appending explicit constraints to the prompt sentence.” By combining such rule-based modifications of prompts with model-based text generation, the server implements a processing pattern that has no direct human analog and that optimizes the interplay between symbolic control and subsymbolic generation. This results in lower variance of plan quality and more predictable system behavior.
In all of these embodiments, the server does not merely automate what a human tutor or supervisor would do manually. Instead, the server implements a new computational pattern in which quantitative indices of understanding and emotion are continuously mapped into prompt sentences that control a generative AI model. The generative AI model in turn produces structured outputs that feed back into the evaluation and selection algorithms. This feedback loop, implemented through specific data structures, machine-learning models, prompt-construction rules, and content-selection mechanisms, constitutes an improvement in the operation of the computer itself, in that it achieves higher accuracy, lower latency, and reduced communication overhead compared to conventional systems that either rely on static rules or invoke generative models without programmatic prompt control.

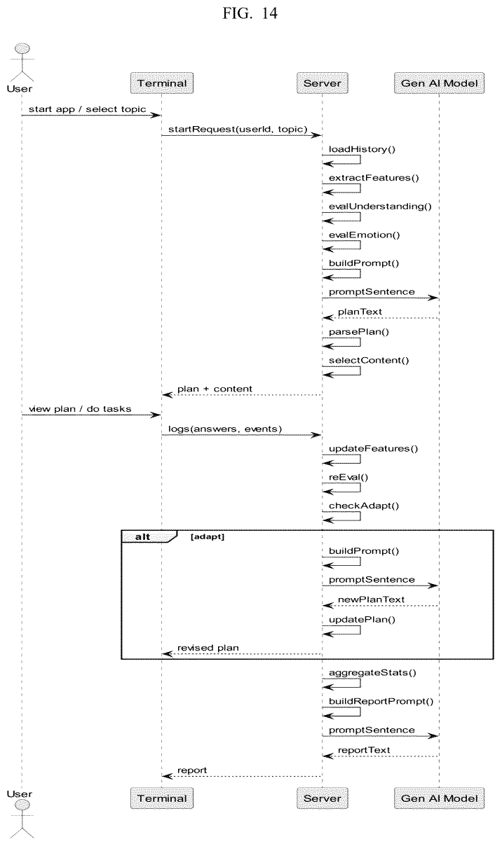

The following describes the processing flow using FIG. 14.

### Step 1:

User operates the terminal to start an application and select a learning or work target.
User provides input such as subject, topic, or task type through buttons, menus, or voice input on the terminal.
Terminal receives this input and constructs a request message including a user identifier, selected content identifier, device type, and timestamp.
Terminal sends this message to the server over a network connection using a secure protocol.
Input: raw user selection and device information.
Output: a structured request message transmitted to the server, containing normalized identifiers and metadata.

### Step 2:

Server receives the request message and parses the included fields.
Server queries a storage device, such as a relational database, to retrieve existing records of learning history, evaluation results, behavior history, and emotion logs associated with the user identifier.
Server aggregates these records into in-memory data structures, for example, tables or arrays, ordered by time and grouped by topic or task type.
Input: structured request message containing user identifier and selected content identifier.
Output: aggregated raw data sets representing past learning events, behavior events, evaluation results, and emotion records for the user.

### Step 3:

Server executes a feature-extraction module implemented using a numerical computation library and a data-frame library.
Server converts raw history records into feature vectors by computing, for each topic or task, statistics such as correct-answer rate, average response time, number of attempts, time since last exposure, and frequency of help requests.
Server normalizes these statistics using, for example, min-max scaling or z-score transformation and encodes categorical attributes as numeric values.
Input: aggregated raw data sets of learning history, behavior history, and evaluation results.
Output: standardized feature vectors that numerically represent user behavior and performance per topic or task.

### Step 4:

Server applies a pre-trained machine-learning model, such as a gradient-boosted tree or a multilayer perceptron, to the feature vectors.
Server feeds each feature vector into the model to compute an understanding index and, optionally, a weak-field index and a work-skill-level index.
Server assigns labels such as “weak,” “intermediate,” or “strong” to each topic by comparing the understanding index against predetermined thresholds.
Input: standardized feature vectors.
Output: an evaluation result object including understanding indices, weak-field flags, and skill-level estimates per topic or task.

### Step 5:

Terminal captures sensor data during user interaction, such as camera images and microphone audio, if available and permitted.
Terminal optionally compresses or downscales this data and sends it to the server at defined intervals.
Server receives the sensor data and uses an image-processing library to detect and crop the face region and to extract visual features.
Server uses a deep-learning model, such as a convolutional neural network, and optionally a text-analysis model to infer an emotional-state index and a confidence score.
Input: raw sensor data (image frames, audio segments, and/or text transcripts).
Output: an emotional-state index and associated metadata stored as an emotion log entry.

### Step 6:

Server combines the evaluation result object and the emotional-state index into a unified session-context structure.
Server passes this structure to a prompt-management module.
Server selects a base template for a prompt sentence depending on the selected content type (for example, learning plan, work plan, tutoring dialog, or report).
Server fills template slots with numeric values and descriptive phrases representing user profile, understanding indices, weak topics, emotional-state index, and time constraints.
Input: evaluation result object, emotional-state index, user profile, and session parameters.
Output: a prompt sentence text string that encodes instructions and context for a generative AI model.

### Step 7:

Server sends the prompt sentence to a generative AI model through an application programming interface.
Server provides the prompt as text input, optionally with additional parameters such as maximum output length and temperature.
Server receives a text output from the generative AI model that may describe a learning plan, a work plan, a dialog response, or a report segment in natural language.
Server parses the output using pattern matching or lightweight natural-language processing to extract structured elements such as steps, items, difficulty levels, and time estimates.
Input: prompt sentence and, optionally, supplementary structured context.
Output: parsed response information, including structured plan elements or dialog or report content.

### Step 8:

Server converts the parsed response into an internal plan representation.
Server creates entries for each step, specifying learning items or work tasks, associated difficulty levels, execution order, and estimated times.
Server stores this representation in a session-plan table and tags it with version information to support later updates.
Input: parsed response information from the generative AI model.
Output: a structured personalized plan object stored and indexed in the server.

### Step 9:

Server queries content-metadata tables to retrieve candidate learning materials or work procedures that match each step of the personalized plan.
Server filters candidates by topic, difficulty, and estimated time, and ranks them using historical effectiveness metrics such as average improvement in understanding index or reduced completion time.
Server assigns one or more content items to each step and creates a content list linked to the plan.
Input: structured personalized plan and content metadata.
Output: a plan enriched with selected content identifiers and associated access paths.

### Step 10:

Server sends the enriched personalized plan and content list to the terminal via a network response.
Terminal receives the response and updates the user interface to display steps, assigned materials, difficulty indicators, and progress bars.
Terminal initializes local state to track which step is active, how much time has elapsed, and which content is currently presented.
Input: enriched personalized plan and content list from the server.
Output: a rendered user interface that presents the plan and content to the user.

### Step 11:

User follows the instructions displayed on the terminal, accesses content, and answers questions or performs tasks.
Terminal records user actions, including item identifiers, answer content, correctness indicators, timestamps, and help requests.
Terminal periodically sends batches of these event logs to the server, either after each action or at defined intervals.
Input: user interactions as raw event data.
Output: structured log entries transmitted to the server for further analysis.

### Step 12:

Server receives the event logs and appends them to learning-history and behavior-history tables.
Server re-runs feature extraction incrementally on the new data, updating only affected feature vectors to have up-to-date statistics.
Server recalculates understanding indices and, optionally, emotional-state indices for topics related to the current session.
Input: new event log entries from the terminal.
Output: updated feature vectors and updated evaluation results for the user.

### Step 13:

Server determines whether the changes in understanding index or emotional-state index exceed configurable thresholds that trigger adaptation.
If a threshold is exceeded, server reconstructs a new prompt sentence that summarizes recent performance and emotional state and explicitly requests a revised plan or adjusted dialog content.
Server sends the new prompt sentence to the generative AI model, receives updated response information, and converts it into a revised personalized plan or modified dialog instructions.
Input: updated evaluation results and emotion indices.
Output: revised prompt sentence, updated generative response, and an adjusted plan or dialog specification.

### Step 14:

Server notifies the terminal about plan or dialog adjustments.
Terminal modifies the user interface accordingly, for example by inserting a review step, changing difficulty labels, or altering the tone of displayed instructions.
User experiences a dynamically adapted sequence of tasks and explanations that reflect current understanding and emotional state.
Input: adjusted plan or dialog specification from the server.
Output: updated on-screen content and interaction flow that implement the adjusted plan.

### Step 15:

Server periodically aggregates accumulated data for reporting purposes.
Server computes learning-progress information, understanding-transition information, and emotional-state-transition information over a configurable time window.
Server constructs a prompt sentence that describes these aggregated metrics and requests a concise summary and recommendations.
Server sends this prompt sentence to the generative AI model, receives summary sentences and advice sentences, and combines them with graphical or tabular data.
Input: aggregated evaluation results and historical emotion and progress metrics.
Output: report information containing numeric data, visualizable structures, and natural-language summaries suitable for presentation to the user and related persons.

The data generation model 58 is a so-called generative artificial intelligence (AI). Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

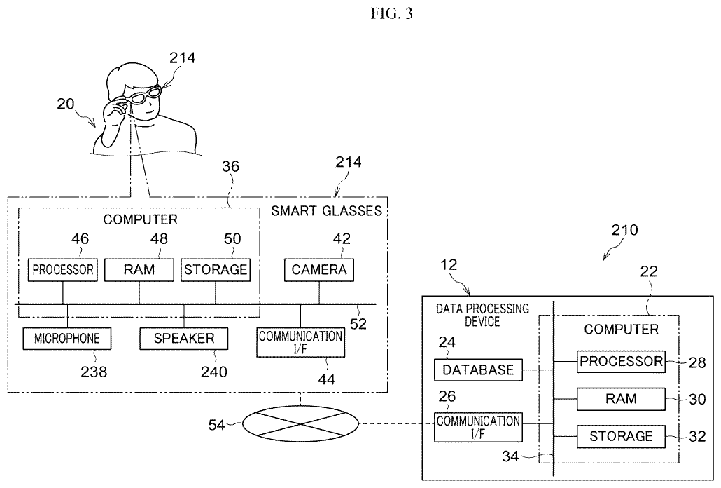

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

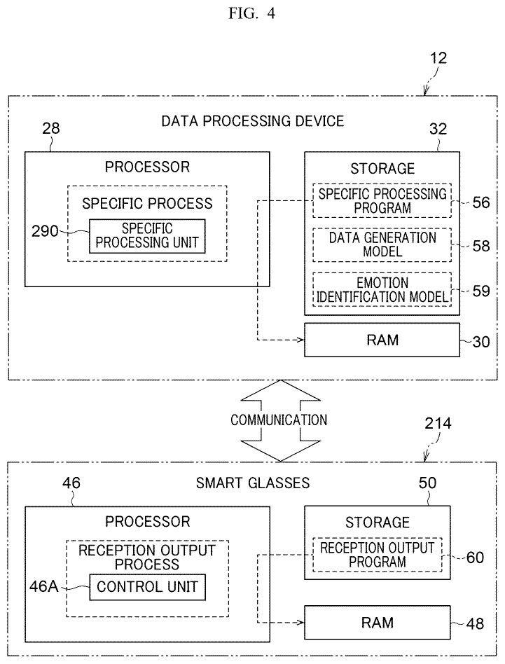

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

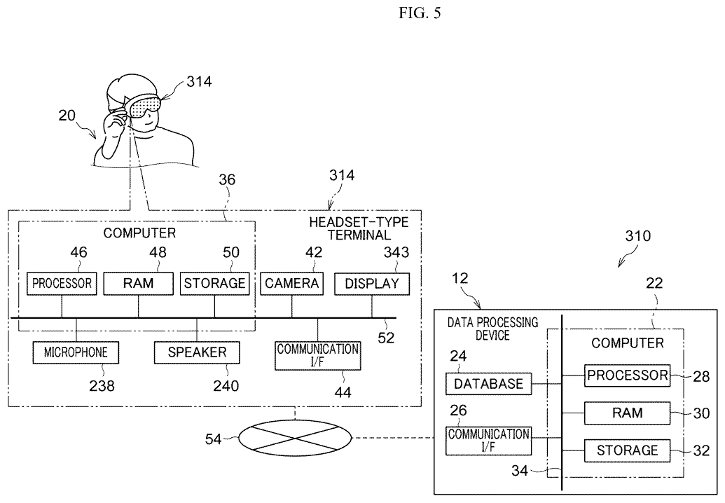

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

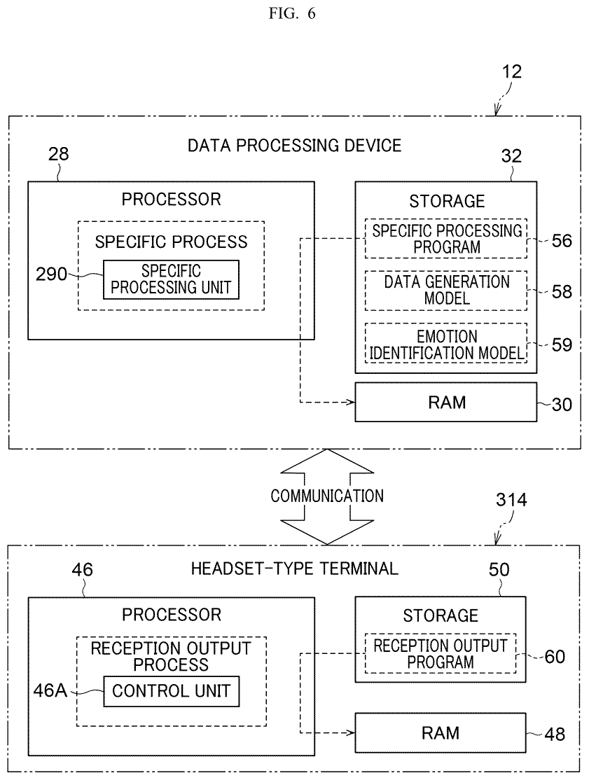

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

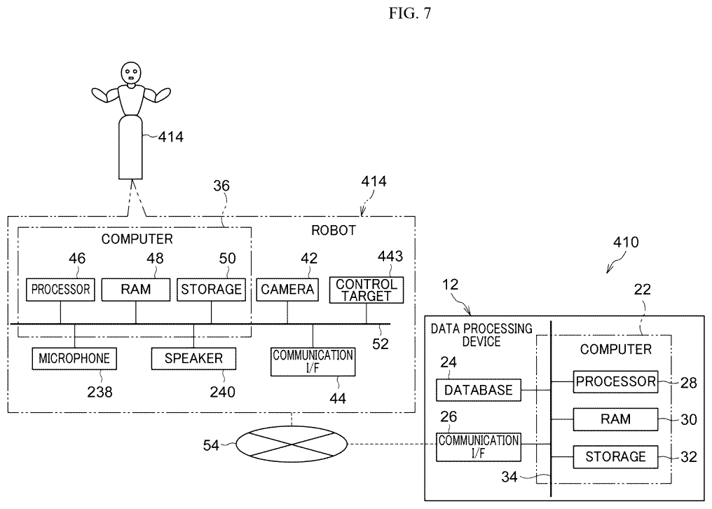

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

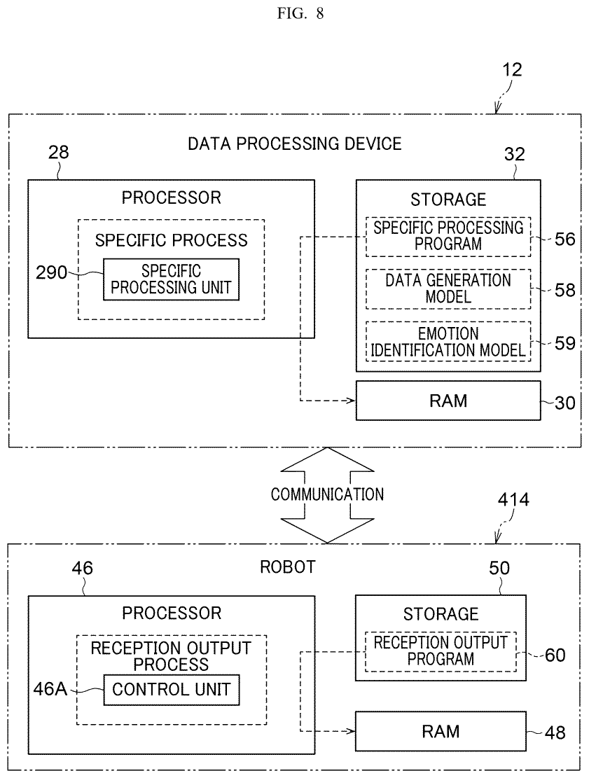

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

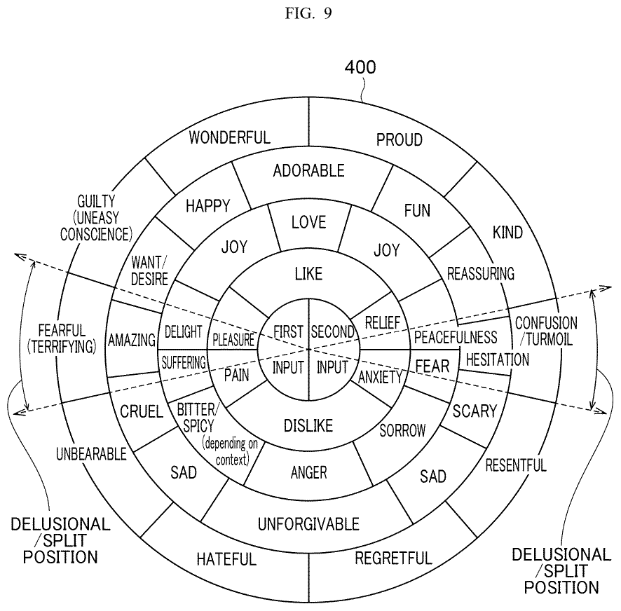

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

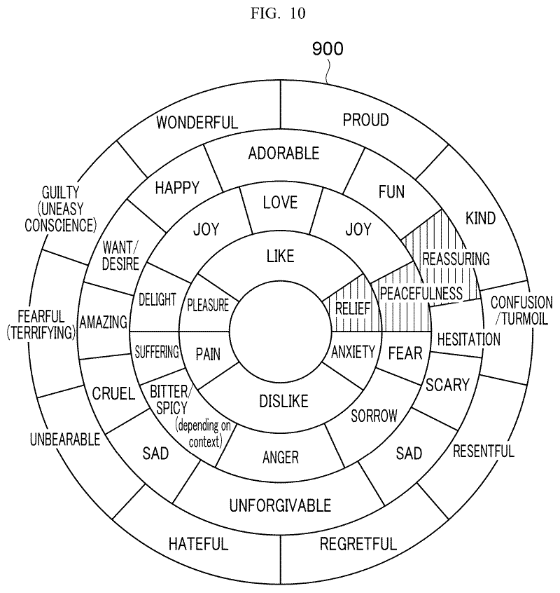

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via an input/output device, information related to learning from a user,
construct, on the basis of the received information and stored learning-history information and feedback information, a prompt sentence to be input to a generative AI model that utilizes natural language processing, and supply the prompt sentence to the generative AI model so as to cause the generative AI model to analyze an intention and an understanding level of the user, and generate learner-state information indicating a learning state for each user based on an analysis result,
dynamically generate, in accordance with the learner-state information, a prompt sentence that instructs the generative AI model to generate a response, and supply the prompt sentence to the generative AI model so as to cause the generative AI model to generate learning-response information customized for each user,
transmit the generated learning-response information to the input/output device so as to present the learning-response information to the user,
acquire, via the input/output device, evaluation information or request information input by the user with respect to the learning-response information, analyze the evaluation information or the request information to update prompt-generation conditions for each user, and reflect the prompt-generation conditions in a prompt sentence to be supplied to the generative AI model on a subsequent occasion so as to continuously optimize content and expression format of the response.

### (Supplementary 2)

The system according to supplementary 1,
wherein the processor is configured to
include, in the prompt-generation conditions, parameters relating to a degree of detail of explanation, a level of expression to be used, presence or absence of examples, and structure and amount of the explanation, and automatically adjust the parameters on the basis of the feedback information and the learning-history information from the user so as to adaptively change, for each user, the prompt sentence to be supplied to the generative AI model.

### (Supplementary 3)

The system according to supplementary 1,
wherein the processor is configured to
supply, to the generative AI model, a prompt sentence for automatically generating learning-status report information including learning-progress information and understanding-degree information for each user, on the basis of the learning-history information of the user, the feedback information, and the analysis result obtained from the generative AI model, and cause learning-status report information generated by the generative AI model to be notified to the user and to a related party.

### Application Example 1

### (Supplementary 1)

A system comprising a processor, a communication apparatus, a learning history information storage apparatus, and a generative artificial intelligence model,
wherein the processor is configured to
receive learning request information from a user via the communication apparatus,
analyze a natural language expression including the learning request information by using a natural language processing technique to identify a learning target domain, a learning proficiency level, and a learning intention,
acquire learning history information associated with the user from the learning history information storage apparatus and generate feature data based on the learning history information,
calculate a comprehension index of the user by applying a machine learning model to the feature data and the learning target domain,
generate learning strategy information by selecting a learning method, a content type, and a content difficulty level according to the comprehension index and the learning intention,
construct a prompt sentence to be input to the generative artificial intelligence model, the prompt sentence being based on condition information including the learning strategy information, the comprehension index, and the learning history information,
cause the generative artificial intelligence model to generate learning content information including explanation information, exercise information, and evaluation information by inputting the prompt sentence to the generative artificial intelligence model, and acquire a generated result as structured data,
select content information to be presented to the user based on the learning content information and the learning strategy information, and transmit the content information to a user terminal via the communication apparatus,
update the learning history information and the comprehension index based on learning result information acquired from the user terminal, and generate learning report information according to an update result, and
construct a prompt sentence for generating an explanatory text including the learning report information and provide the prompt sentence as input to the generative artificial intelligence model.

### (Supplementary 2)

The system according to supplementary 1,
wherein the processor is configured to dynamically change the prompt sentence to be input to the generative artificial intelligence model according to the learning request information of the user, the learning history information, the comprehension index, and learning progress information, and to sequentially update dialogue content and presented content.

### (Supplementary 3)

The system according to supplementary 1,
wherein the processor is configured to automatically generate a report prompt sentence including report content, recommended learning items, and a subsequent learning plan to be provided to the user and a related party, based on the learning result information and the comprehension index, and to cause the generative artificial intelligence model to generate and output a natural language report according to the report prompt sentence.

### Example 2

### (Supplementary 1)

A system comprising a processor,
wherein the processor is configured to
acquire user-related information by receiving identification information of a user and information on a learning target through an interface and by acquiring learning history information and evaluation result information corresponding to the user from a storage device,
evaluate a comprehension level of the user by performing statistical processing or machine learning processing on the acquired user-related information and the learning history information to calculate a numerical comprehension indicator,
generate a learning progress indicator including time-series information based on an evaluation result, and generate visualization information including graph information or report information representing the learning progress indicator,
generate a prompt sentence including structured data regarding the evaluation result and the learning progress indicator, input the prompt sentence to a generative AI model, and acquire a natural-language explanatory text regarding a learning policy or a learning plan for the user from the generative AI model,
add the explanatory text to the report information to generate learning report information, and transmit the learning report information in an electronic document format to a user terminal, and
generate a control prompt sentence for individually adjusting a learning plan of the user and controlling presentation of educational information resources based on the learning report information.

### (Supplementary 2)

The system according to supplementary 1,
wherein the processor is configured to
perform data preprocessing by extracting the learning history information and the evaluation result information from the storage device based on the identification information of the user and the information on the learning target, and by transforming the extracted information into a format suitable for the statistical processing or the machine learning processing.

### (Supplementary 3)

The system according to supplementary 1,
wherein the processor is configured to
generate the prompt sentence input to the generative AI model by embedding, into the prompt sentence, structured data including a comprehension evaluation value for each user, an achievement degree for each learning unit, a change in comprehension level over time, and a learning effectiveness indicator for each type of educational material, and to acquire, from the generative AI model, a response text including an explanatory text and a recommended action for dynamically changing interactive content or report content according to a learning progress and an emotional state of the user.

### Application Example 2

### (Supplementary 1)

A system comprising a processor,
wherein the processor is configured to
receive input information via an information input/output device configured to receive information from a user, the input information including at least information on learning content, learning history, evaluation result, behavior history, and emotional state of the user; and
generate feature data, by using character information processing and statistical processing, based on the input information, the feature data being used to calculate, for each learning item, at least an understanding index, a weak-field index, a work-skill-level index, and an emotional-state index, and evaluate the understanding and the emotional state of the user in a numerical or categorical form by applying machine learning processing to the feature data; and
create a prompt sentence including an instruction sentence to be input to a generative information processing model, based on an evaluation result obtained by the evaluation, the prompt sentence including at least a user profile, the understanding evaluation result, the emotional-state index, and constraint conditions relating to a learning or work session, and input the prompt sentence to the generative information processing model to cause the generative information processing model to generate response information including at least one of a learning plan, a work instruction, dialog content, and report content; and generate, based on the response information, a personalized plan including at least one of a learning plan and a work plan, the personalized plan specifying at least a learning item or work item, difficulty level, execution order, and required time, and select and associate, from an information storage device, content information including at least one of learning-material information and work-procedure information corresponding to the personalized plan; and present the personalized plan and the content information via a user interface, sequentially acquire, from the user, additional information including at least answer information, operation information, and additional emotional-state information, update the evaluation result based on the acquired additional information, and, when necessary, regenerate the prompt sentence and re-input the regenerated prompt sentence to the generative information processing model so as to dynamically readjust the learning plan or the work plan; and generate report information based on the evaluation result and an execution result of the personalized plan, the report information including at least learning-progress information, understanding-transition information, emotional-state-transition information, and recommended measures, and output the report information in a form that is notifiable to the user and a related person.

### (Supplementary 2)

The system according to supplementary 1,
wherein the processor is configured to
generate, as the prompt sentence, a dialog prompt sentence including instructions relating to at least a level of detail of an explanation, a difficulty of terminology, a presence or absence of encouraging expressions, and a question difficulty, based on the understanding evaluation result and the emotional-state index of the user, and input the dialog prompt sentence to the generative information processing model so as to generate dialog response information for dynamically changing dialog content with the user.

### (Supplementary 3)

The system according to supplementary 1,
wherein the processor is configured to
aggregate learning-progress information and emotional-state-transition information over time, generate visualization data based on an aggregation result, generate a report prompt sentence to input structured information including the visualization data to the generative information processing model, acquire a summary sentence or an advice sentence from the generative information processing model based on the report prompt sentence, incorporate the acquired sentence into the report information so as to automatically update the report information, and notify the updated report information to the user and the related person.

What is claimed is:

1. A system comprising:
a communication interface coupled to a packet-switched network; and
circuitry configured to:
receive, via the communication interface, input data from a terminal device, and store the input data in a storage device in association with a session identifier;
construct, based on the input data and stored history information and feedback information associated with the session identifier, a first prompt for a generative neural network model, and supply the first prompt to the generative neural network model to cause the generative neural network model to analyze the input data and generate state information indicating a current state of processing for the session identifier;
dynamically generate, in accordance with the state information, a second prompt that instructs the generative neural network model to generate customized response information, and supply the second prompt to the generative neural network model to acquire the customized response information;
transmit the customized response information to the terminal device via the packet-switched network;
acquire evaluation information from the terminal device with respect to the customized response information, analyze the evaluation information to update prompt-generation conditions for the session identifier, the prompt-generation conditions comprising parameters relating to a degree of detail, a level of expression, and a structural format; and
reflect the updated prompt-generation conditions in at least one subsequent prompt supplied to the generative neural network model to optimize content and format of subsequent responses.

2. The system according to claim 1, wherein the circuitry is further configured to retrieve the history information by querying the storage device using the session identifier to obtain records comprising past input data, correctness scores, difficulty levels, and feedback classifications, and to aggregate the records into the state information.

3. The system according to claim 2, wherein the first prompt is constructed by concatenating instruction segments, the input data, and descriptive phrases generated by deterministic mapping of numeric parameters in the state information to natural-language expressions.

4. The system according to claim 3, wherein the circuitry is further configured to parse output of the generative neural network model responsive to the first prompt by extracting predefined labels and delimiter-separated values to obtain structured analysis codes comprising topic identifiers, intent classifications, and complexity categories.

5. The system according to claim 4, wherein the circuitry is further configured to integrate the structured analysis codes with the state information and to select sentence templates for the second prompt based on the integrated state information, filling template slots with the input data and guidance parameters derived from the state information.

6. The system according to claim 5, wherein the second prompt embeds explicit constraints comprising a target length, an explanation style indicator, and a presence-or-absence flag for illustrative examples.

7. The system according to claim 1, wherein the circuitry is further configured to construct a classification-oriented prompt that embeds feedback text from the evaluation information and instructions for the generative neural network model to label the feedback into predefined categories, and to update the prompt-generation conditions based on the labels.

8. The system according to claim 7, wherein the labels comprise detail-level indicators, expression-simplification flags, and example-inclusion toggles, and wherein the circuitry maps the labels to internal parameter adjustments stored in the storage device in association with the session identifier.

9. The system according to claim 8, wherein the circuitry is further configured to maintain a persistent adaptive profile comprising the session identifier, the state information, the feedback history, and the prompt-generation conditions, and to apply the adaptive profile when constructing all subsequent prompts for the session identifier.

10. The system according to claim 1, wherein the circuitry is further configured to perform natural language processing on the input data comprising tokenization, semantic feature extraction, and emotional-state estimation using a classification model to generate an emotional-state index.

11. The system according to claim 10, wherein the emotional-state index indicates at least one of confusion, frustration, or confidence, and wherein the circuitry incorporates the emotional-state index into the second prompt to adjust a tone parameter and an encouragement-expression parameter of the customized response information.

12. The system according to claim 11, wherein the circuitry is further configured to perform emotion estimation processing on at least one of text data, audio data, or image data received from the terminal device using a neural network classifier trained on labeled emotional-state examples.

13. The system according to claim 1, wherein the circuitry is further configured to generate report data based on the state information and an execution result of a personalized plan associated with the session identifier, the report data comprising progress information, understanding-degree transition information, and emotional-state transition information.

14. The system according to claim 13, wherein the circuitry is further configured to aggregate the progress information and the emotional-state transition information over time, generate visualization data based on an aggregation result, construct a report prompt comprising the visualization data, supply the report prompt to the generative neural network model, and incorporate a summary generated by the generative neural network model into the report data.

15. The system according to claim 14, wherein the circuitry is further configured to transmit the report data to the terminal device and to at least one additional terminal device associated with a related party via the packet-switched network.

16. The system according to claim 1, wherein the input data comprises learning-related queries from a user, the customized response information comprises educational content adapted to the user, and the personalized plan comprises a learning plan adjusted based on the state information.

17. The system according to claim 16, wherein the circuitry is further configured to calculate a closed-loop induction rate based on a ratio of accepted customized responses to total generated responses for the session identifier, and to adjust generation conditions of the generative neural network model when the induction rate falls below a threshold.

18. A system comprising:
a communication interface coupled to a packet-switched network; and
circuitry configured to:
receive input data from a terminal device via the communication interface, retrieve history information and feedback information from a storage device using a session identifier, and construct a first prompt by concatenating instruction segments, the input data, and natural-language expressions mapped from numeric parameters in state information derived from the history information;
supply the first prompt to a generative neural network model to obtain structured analysis codes comprising topic identifiers, intent classifications, and complexity categories, and integrate the analysis codes with the state information;
generate a second prompt by selecting sentence templates based on the integrated state information and embedding explicit constraints comprising target length, explanation style, and example-inclusion parameters, and supply the second prompt to the generative neural network model to acquire customized response information;
transmit the customized response information to the terminal device, acquire evaluation information from the terminal device, construct a classification-oriented prompt to label the evaluation information into predefined feedback categories, and update prompt-generation conditions for the session identifier based on the feedback categories;
perform emotion estimation processing on input data received from the terminal device to generate an emotional-state index, and incorporate the emotional-state index into subsequent prompts to adjust tone and encouragement parameters; and
generate report data comprising progress information, understanding-degree transition information, and emotional-state transition information, and transmit the report data to the terminal device and to at least one additional terminal device via the packet-switched network.

19. The system according to claim 18, wherein the circuitry is further configured to maintain a persistent adaptive profile associating the session identifier with the state information, the feedback history, and the prompt-generation conditions, and to apply the adaptive profile to all subsequent prompt construction operations for the session identifier.

20. A method comprising:
receiving, by circuitry coupled to a packet-switched network, input data from a terminal device, and storing the input data in a storage device in association with a session identifier;
constructing, based on the input data and stored history information and feedback information associated with the session identifier, a first prompt for a generative neural network model, and supplying the first prompt to the generative neural network model to generate state information indicating a current state of processing for the session identifier;
dynamically generating, in accordance with the state information, a second prompt that instructs the generative neural network model to generate customized response information, and supplying the second prompt to the generative neural network model to acquire the customized response information;
transmitting the customized response information to the terminal device via the packet-switched network;
acquiring evaluation information from the terminal device, analyzing the evaluation information to update prompt-generation conditions for the session identifier, and reflecting the updated prompt-generation conditions in at least one subsequent prompt to optimize content and format of subsequent responses.
